(19) United States
(12) Patent Application Publication
(10) Pub. No.: US 2005/0108021 A1
(43) Pub. Date: May 19, 2005

(54) System and method for routing and managing service requests

(76) Inventors: Greg Anderson, Atlanta, GA (US); Peter Clarke, London (GB); Berry Groenestijn, Mumbai (IN); Richard Jones, Sevenoaks (GB); Jim Montgomery, Glascow (GB); Steve Unterberger, Laguna Beach, CA (US)

Correspondence Address: James P. Muraff, Esq.;WALLENSTEIN & WAGNER, LTD, 53rd Floor, 311 South Wacker Drive, Chicago, IL, 60606-6630, US

(21) Appl. No.: 10/631,677

(22) Filed: Jul. 31, 2003

(51) Int. Cl. G06F 17/60

(52) U.S. Cl. 705/1

(57) ABSTRACT

The disclosure presents a method for routing and managing service requests. A service request is received from a service requester, and a determination is made as to which of a plurality of service-providing nodes the service request should be transmitted. The service request is transmitted to the determined service-providing node. The service request may comprise one or more attributes describing the service request, and the determination as to which of the service-providing nodes the service request is transmitted may be based on the value of the one or more service request attributes. The service request may be divided into portions, each portion transmitted to a service-providing node. Information received from a service-providing node may enable an evaluation of whether and why a service request was not fulfilled.

### TECHNICAL FIELD

The present invention is related to a method for routing and managing service requests. More particularly, the present invention relates to a method for routing and managing service requests by receiving a service request from a service requestor and determining to which of a plurality of service-providing nodes the service request will be transmitted.

### BACKGROUND OF THE INVENTION

The outsourcing of business functions has become a critical strategy for companies seeking to maintain efficiency and competitiveness. The business strategy of outsourcing various portions of the Human Resources (“HR”) function, for example, payroll, has been known for decades. The comprehensive outsourcing of entire business functions, for example, accounting, has only recently moved to the fore of mainstream corporate strategy.

Outsourcing links the many discreet sub-processes of a particular outsourced function, for example, HR, thereby improving the overall efficiency of that function. This linking of the many HR sub-processes has given rise to a commercial need: a method which integrates not only the data-intensive HR functions, but also links internal service data with data provided by third parties.

The processes linked by these HR outsourcing options are increasingly using an “event-based” approach, which may include: an integrated method of service delivery for HR programs such that all employees may see all HR-related responses to a work or life event within appropriate times; a “single platform” view of integrated technologies, facilitating administration and processing of data from a variety of sources; and thorough integration of the suppliers of goods and services into the delivery system, including the ability to substitute suppliers in and remove suppliers from the system without compromising the system itself or the front-end experience of the employee/user. The results of such an integrated approach increase the standardization of HR sub-processes throughout the entire HR system and aid managers in identifying areas in need of improvement.

To more efficiently integrate HR services, HR outsourcing providers must take responsibility for all third party providers and suppliers in such a way so as to deliver better service to client firms and their employees. Often, an outsourcing firm will tightly control its delivery platform by working with only a small number of allied partners under its direction.

At the same time, a system and method for managing requests provides employees with access to increasingly high-quality HR services that allow the greatest freedom to manage their own particular needs and requirements. Improved service to employees may include single points of access for HR services and a system to provide escalating levels of response according to the employees' needs ranging from on-screen information to live call-center contact.

The present HR outsourcing options show a plethora of disparate activities that require amalgamation and piecemeal integration to achieve increased levels of efficiency and savings. Most companies, for example, use hundreds of HR service suppliers who provide goods and services to the company via its HR department. Problems of compatibility between the many different systems and overlap between the services they provide is a primary inefficiency faced by many corporate HR departments. Thus, rationalizing and reducing the number of suppliers is a primary goal of leading HR outsourcing firms.

A goal of HR outsourcing firms is to provide service offerings that manage increasingly larger numbers of processes and sub-processes within corporations with increasing speed, accuracy, and cost-reduction. Despite the advances in the field toward this end, the industry is in need of a more efficient system and method for routing, managing, and fulfilling service requests within a system having a plurality of locations where the efficiency and effectiveness of addressing the service requests varies amongst the plurality of locations.

The present invention is provided to solve these and other problems.

### SUMMARY OF THE INVENTION

The present invention provides a method for routing and managing service requests. A service request is received from a service requester, and a determination is made as to which of a plurality of service-providing nodes the service request should be routed. The service is transmitted to at least one of the service-providing nodes.

The service request may be formatted into a predetermined service request format, and a unique service request identifier may be assigned to the service request for the purpose of tracking and managing the request.

A determination may be made as to whether the service request contains all of the information necessary to fulfill the service request. If the answer to this determination is negative, the service request may be transmitted to the service requestor for the provision of the required information.

A determination may also be made as to whether fulfillment of the service request requires authorization from an authorization provider. If the answer to this determination is affirmative, the service request may be transmitted to an authorization provider for the provision of the authorization of the service request.

Fulfillment of the service request may require that the service request be routed to more than one service-providing node. A determination as to whether routing the service request to more than one service-providing node may be made. If the answer to this determination is affirmative, the service request may be divided into a plurality of portions, and each of the plurality of portions may be transmitted to a separate one of the plurality of service-providing nodes.

If the service request is divided into a plurality of portions, fulfillment information may be received from at least one of the plurality of service-providing nodes to which the portion of the service request was sent. Upon receipt of the portions of the service request, the fulfillment information from the plurality of service-providing nodes may be assembled. Even if the service request is transmitted to only one service-providing node, fulfillment information related to the service request may still be received from that service-providing node.

Based on the fulfillment information received from the service-providing node or nodes, a determination may be made as to whether the service request was fulfilled. The answer to this determination may be transmitted to the service requester. If the answer to this determination is negative, the service request may be transmitted to a service-providing node, either the same service-providing node or a different service-providing node, upon a determination that a deficiency which resulted in the non-fulfillment of the service request has been overcome or is no longer relevant.

If a determination is made that a service request was not fulfilled, an additional determination may be made as to why the service request was not fulfilled, and this second explanatory determination may be transmitted to the requestor.

The status of the service request may be monitored throughout the implementation of this method. A request may be received from a service requestor for the status of a service request, and the status of that request may be transmitted to the service requestor. Information related to the service request may be retrievably stored.

The service request may contain at least one attribute. The at least one attribute may be evaluated, and a response to the service request may be proposed based on the evaluation of the at least one attribute.

Other features and advantages of the invention will be apparent from the following specification taken in conjunction with the following drawings.

### BRIEF DESCRIPTION OF THE DRAWINGS

FIG. 1 is an illustration of a method in accordance with the present invention, showing generally the stages of receiving a service request, formatting and analyzing the request, and routing the request to at least one service-providing node.

FIG. 2 is an illustration of a method in accordance with the present invention, showing generally the stages of routing a service request to at least one service-providing node, receiving fulfillment information from the at least one service-providing node, and assembling fulfillment information.

FIG. 3 is an illustration of a method in accordance with the present invention, showing generally the stages of analyzing fulfillment information, routing fulfillment information to a service requester, routing a service request if necessary to at least one service-providing node, and closing a service request.

FIG. 4 is a table constructed in accordance with the principles of the present invention. The table illustrates service requests described by various attributes related to the particular service requested by the service request, and how those attributes may be used to determine to which service-providing node a service request should be transmitted.

FIG. 5 is another table constructed in accordance with the principles of the present invention. This table illustrates how service requests may be described by various attributes related to the format of the service request itself.

FIG. 6 is another table constructed in accordance with the principles of the present invention. This table illustrates how service requests may be described by various attributes related to the business rules directing the fulfillment of the service request, and how those attributes may be used to evaluate the fulfillment or non-fulfillment of a service-request.

### DETAILED DESCRIPTION

While this invention is susceptible of embodiment in many different forms, there are shown in the drawings and herein described in detail preferred embodiments with the understanding that the present disclosure is to be considered an exemplification of the principles of the invention and is not intended to limit the broad aspect of the invention to the embodiments illustrated.

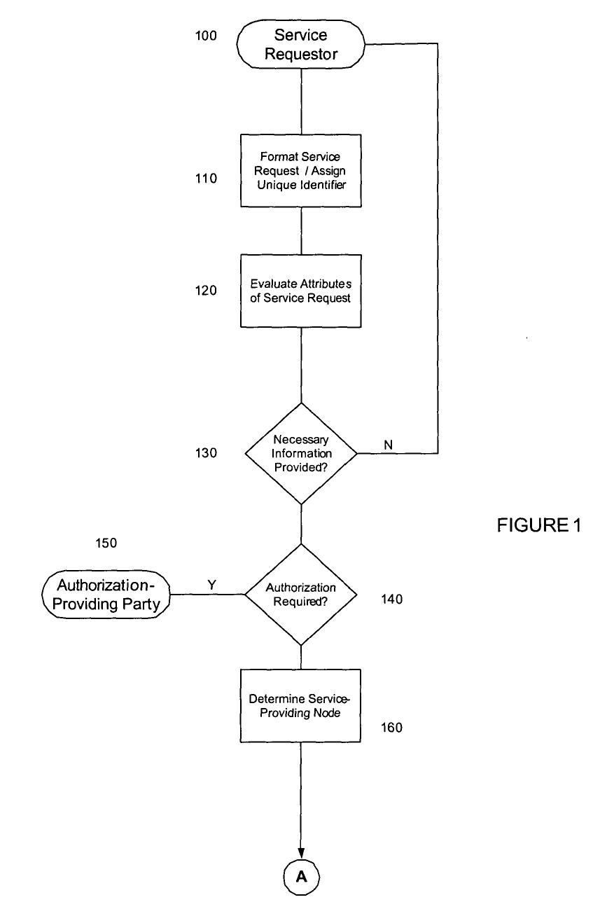

Referring in detail to the drawings and initially to FIG. 1, there is shown a method for routing and managing service requests in accordance with the present invention. A service request is received from a service requestor 100. The service requestor 100 may be an employee within the organization responsible for routing and managing the service request, or may be an employee of another organization. The service requestor 100 may also be a computer program or portion of a computer program. A variety of service requests may be received from the service requestor 100. For example, the service request may be for a certain task to be performed, such as “move this equipment.” The service request may be for the provision of a clerical or administrative task, such as “give a raise to this employee.” The service request may simply be a request for information, such as “display accounts receivable.” The service request may be to record information on paper or in a computer database. The service request may be related to personnel, such as recording the hiring or termination of an employee. The service request may be related to accounting, such as recording or preparing an invoicing statement. Other service requests are contemplated within the scope of the present invention.

The service requestor 100 may submit the service request in a variety of ways. For example, the submission medium may be a website interface via either an intranet or The Internet, electronic mail, written and posted mail, a telephone call, a written memorandum, or an oral request.

The service request may be formatted into a predetermined service request format, illustrated in FIG. 1 as step 110. The predetermined service request format may be a standard form completed by the requestor 100, or may be a standardized electronically-formatted document as part of a software system. The predetermined format of the service request provides a uniform format for service requests, which aids in a more efficient reading of the form by both human and computer. The service request may be submitted in the predetermined format, for example through a form on a website or by a paper form, or may be received by the system in a non-predetermined form and, in step 110, formatted into a predetermined form. Additionally, different types of forms may have different predetermined formats.

A unique service request identifier may be assigned to the service request. The unique service request identifier may be a numeral, an alphanumerical character, or a symbol; the unique service request identifier may assist in managing and tracking the service request.

The service request may comprise one or more attributes. For example, the service request may have an attribute describing a requestor location, i.e. the physical location of the service requestor 100. The attribute may be a service-providing node 200 location, which may describe the physical location of a service-providing node 200. This attribute may be used when the service requestor 100 specifies the service-providing node 200 to which the service request should be routed.

The service request may also have an attribute describing the location of provider resources, for example, the physical location of where to ship paychecks might be an attribute of a service request for monthly pay distribution. The service request may have an attribute describing the language of the requestor 100, or an attribute describing the service request language. For example, the service requester 100 may speak English, while the service request is written or typed in Spanish. These values, English and Spanish, may be stored as attributes attached to the service request. The service request may also have an attribute describing the subject matter of the service request. For example, the subject matter of the service request may be “invoice” if the service request is related to accounting or invoicing. The service request may have an attribute detailing the time the service request is received, or the time required for fulfillment of the service request. Additionally, the service request may detail the level of confidentiality of the service request, in the event that the service request is for or contains sensitive or confidential information. The attribute may also describe the identify of the requestor 100, for example, Assistant Vice President, or the number of requesters 100 if the service request is made on behalf of multiple requestors 100. Other attributes are contemplated within the scope of the present invention.

The one or more attributes describing the service request may be evaluated, as illustrated in FIG. 1 as step 120. These attributes may be used to determine to which service-providing node 200 the service request will be routed. For example, if the requestor 100 specifies the service-provider node 200 in the service request, this value may be stored as an attribute of the request, and that value may be relied upon to route the service request to that particular service-providing node 200. As another example, if the service request comprises an attribute describing the type of service request, for example, “invoice”, this attribute may be relied upon to transmit the service request to the appropriate service-providing node 200; in this example, the service-providing node 200 associated with invoices. The evaluation of the attributes of the service request in step 120 may be made by a human reviewing the service request, or may be made by a computer software program. Alternatively, the evaluation of the service request in step 120 may be made by a human with the assistance of a computer software program.

A determination may be made as to whether the service request contains all the information necessary for fulfillment of the service request, illustrated in FIG. 1 as step 130. If not all of the necessary information has been provided, the service request may be transmitted to the requestor 100 for the provision of additional information. The determination in step 130 that the service request does not contain information required for its fulfillment may be made by a person reviewing the service request, or may be made by a computer reviewing the service request.

As illustrated in FIG. 1 at step 140, a determination may also be made as to whether fulfillment of the service request requires approval from an authorization-providing authority 150. For example, a service request for hiring of a new employee may be submitted by a requestor 100 who does not have the authority to hire new employees. The service request may be transmitted to an authorization-providing authority 150. The authorization may be received from the authorization-providing authority 150.

The service request is transmitted to a service-providing node, as illustrated in FIG. 1 as step 160. The decision as to which service-providing node the service request is routed may be based on the evaluation of the attributes of the service request in step 120. The decision may also be based on which of the service-providing nodes was used most recently or most remotely. The decision may also be based on the physical location of the service-providing nodes.

Also in step 160, a determination may be made as to whether fulfillment of the service request requires transmitting the service request to more than one of the plurality of service-providing nodes 200. For example, the service request may be for more than one service, or may be for a complicated service involving multiple steps. As another example, the service request may be to hire a new employee; this type of request may involve a personnel service and a distinct accounting service. In this instance, the service request may divided into a plurality of portions, e.g. accounting and personnel, and each of the portions may be transmitted to a separate one of the plurality of service-providing nodes 200. For example, the accounting portion of the service request may be transmitted to the service-providing node 200 associated with accounting services, and the personnel portion of the service request may be transmitted to the service-providing node associated with personnel services.

The plurality of portions into which a service request is divided may each be transmitted to a service-providing node 200 distinct from the others. Or, the portions may be transmitted to the same service-providing node 200. Or, some portions may be transmitted to one service-providing node 200, and other portions may be sent to a second service-providing node 200. Other combinations are possible as well. However, each portion of the service request is transmitted to at least one service-providing node 200.

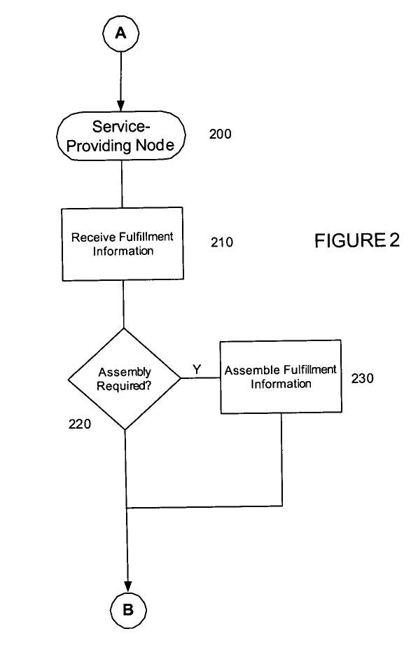

Referring now to FIG. 2, a service-providing node 200 receives a service request. The service-providing node may receive the service request via mail, via electronic mail, via telephone call, via facsimile, via oral communication, or via The Internet or other computer network. Fulfillment information is received from the service-provider node 200 as illustrated in FIG. 2 as step 210. The fulfillment information may be in the form of a service report, or may take the form of a written or otherwise verbal communication expressing information relating to the fulfillment or non-fulfillment of the service request.

If the service request had been divided into a plurality of portions in step 160, fulfillment information may be received from each of the service-providing nodes 200 to which the plurality of portions had been transmitted. A determination may be made as to whether the fulfillment information must be assembled, as illustrated in step 220. If assembly of the fulfillment information is required, that fulfillment information is assembled in step 230. The assembly may be simply the combination of service reports received from the service-providing nodes, or may be a checklist of services to have been completed. The assembly of fulfillment information may be more complicated, involving an analysis of which service-providing nodes fulfilled the service request and which did not.

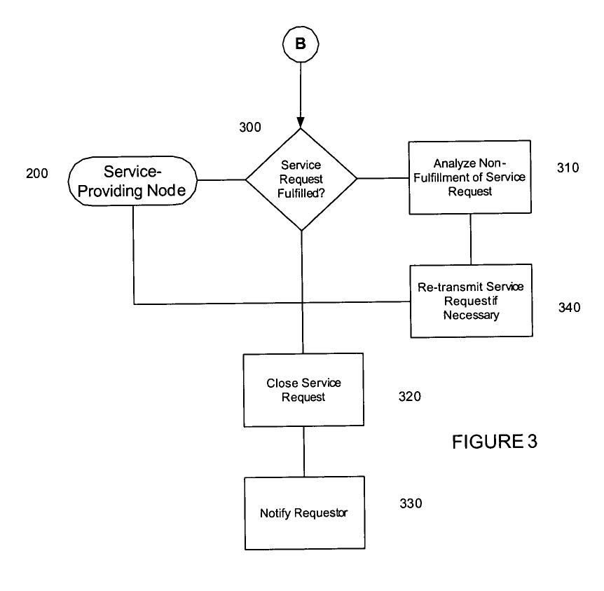

Referring now to FIG. 3, a determination is made as to whether the service request has been fulfilled, as illustrated in step 300. If the service request was not fulfilled, the service request may be transmitted to a service-providing node 200. The service request may be transmitted to the same service-providing node 200, or to a different service-providing node 200, to “retry” the service request. The service request may also be transmitted to the service requestor 100 if not fulfilled. The fulfillment information may comprise information explaining why the service request was not fulfilled, and a determination may be made in step 310 as to whether that deficiency has been overcome or is irrelevant. For example, the fulfillment information may explain that a service request was not fulfilled because the service-providing node was too busy to fulfill the service request. As another example, if in step 310 a determination is made that a different service-providing node 200 is not busy, or that the same service-providing node 200 is no longer busy, the service request may be transmitted to a service-providing node 200. The transmission of a service request to a service-provider node 200 upon the determination that a deficiency has been overcome or is irrelevant is illustrated in FIG. 3 as step 340.

Whether fulfilled or not fulfilled, the service request may be closed in step 320. The service requestor 100 may be notified in step 330 that the service request was fulfilled or not fulfilled.

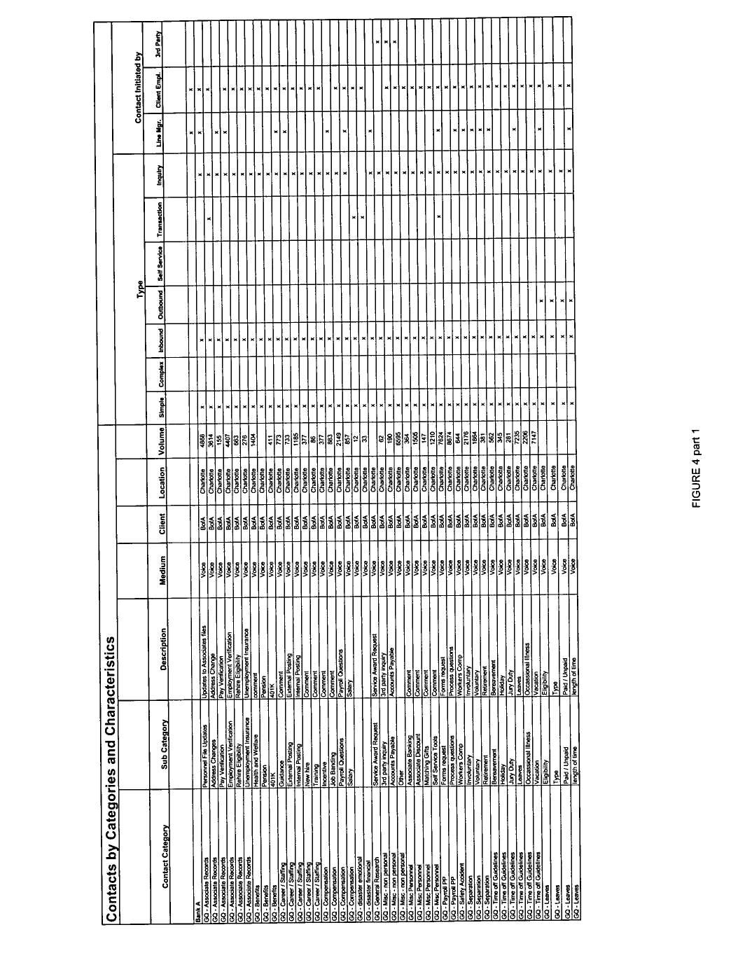

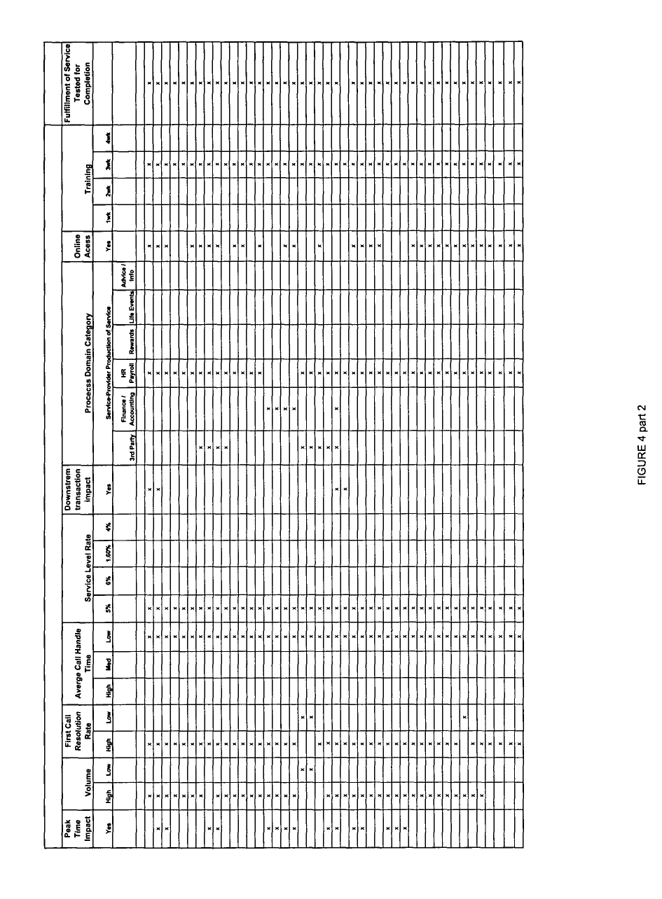

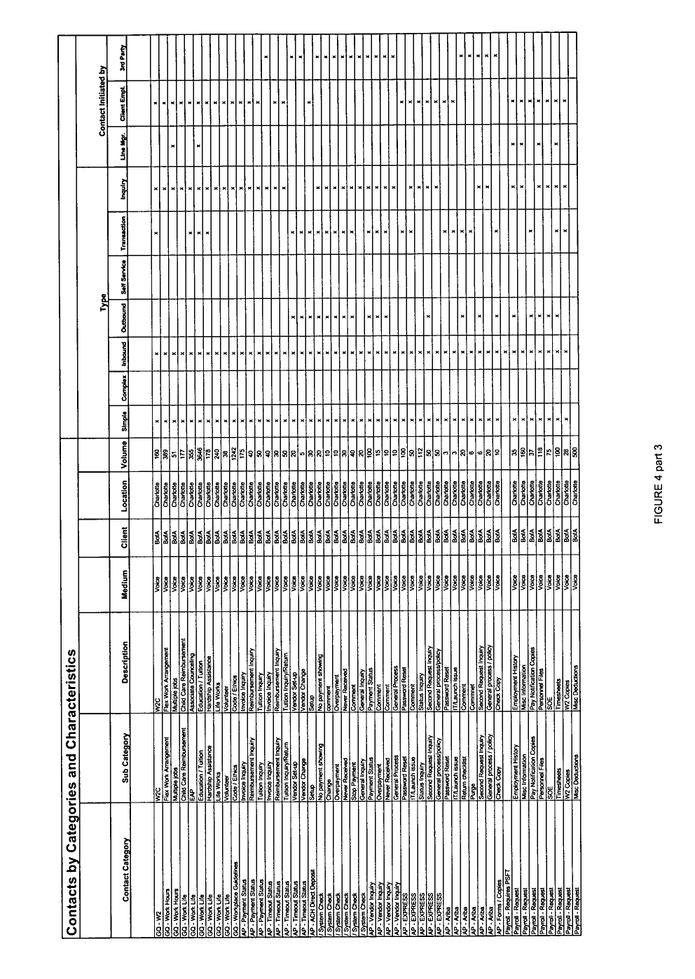

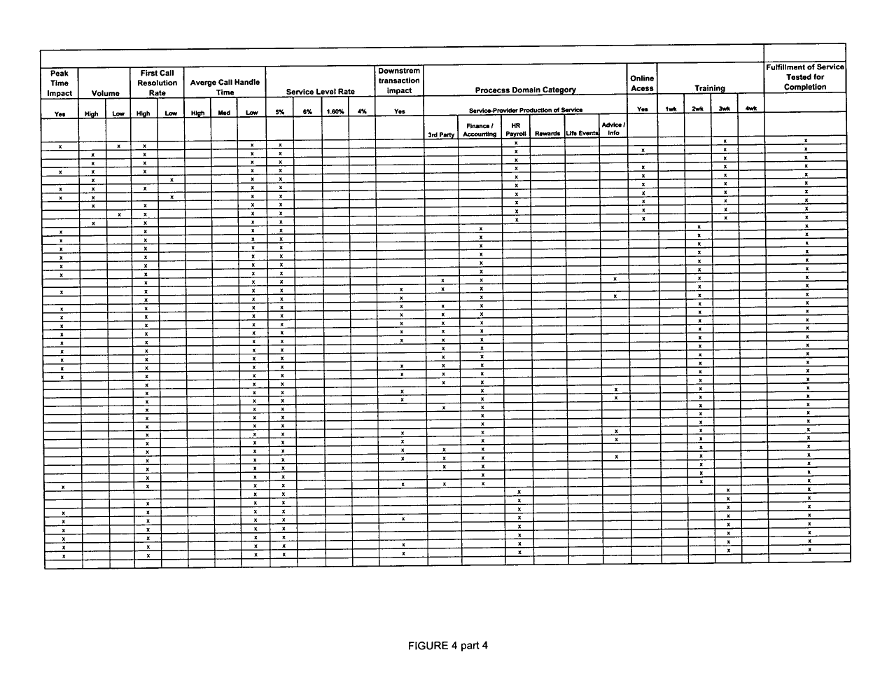

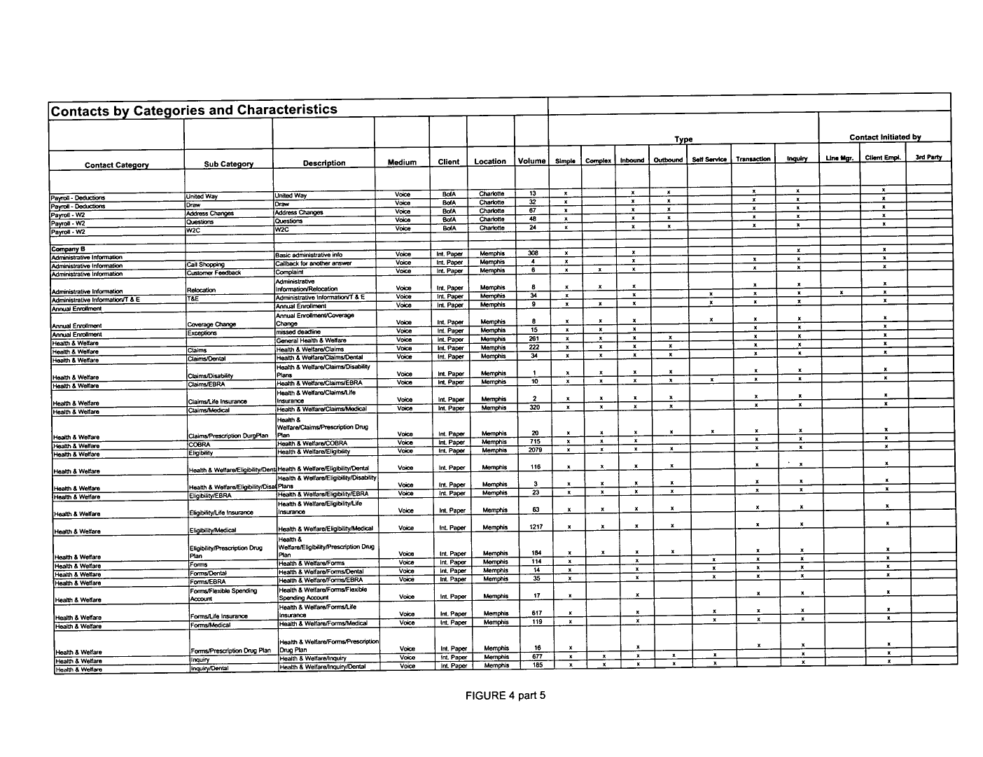

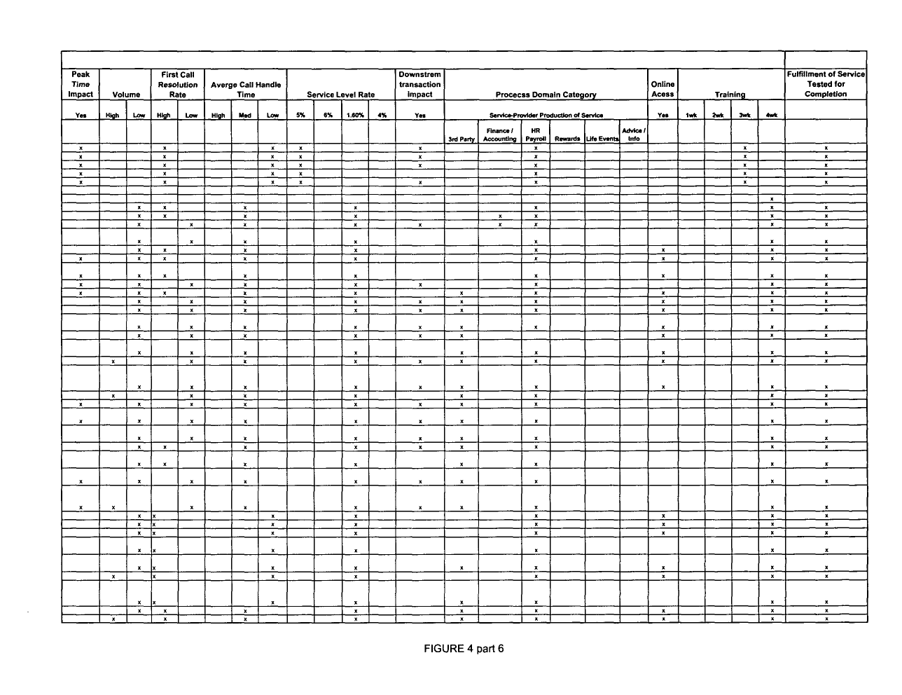

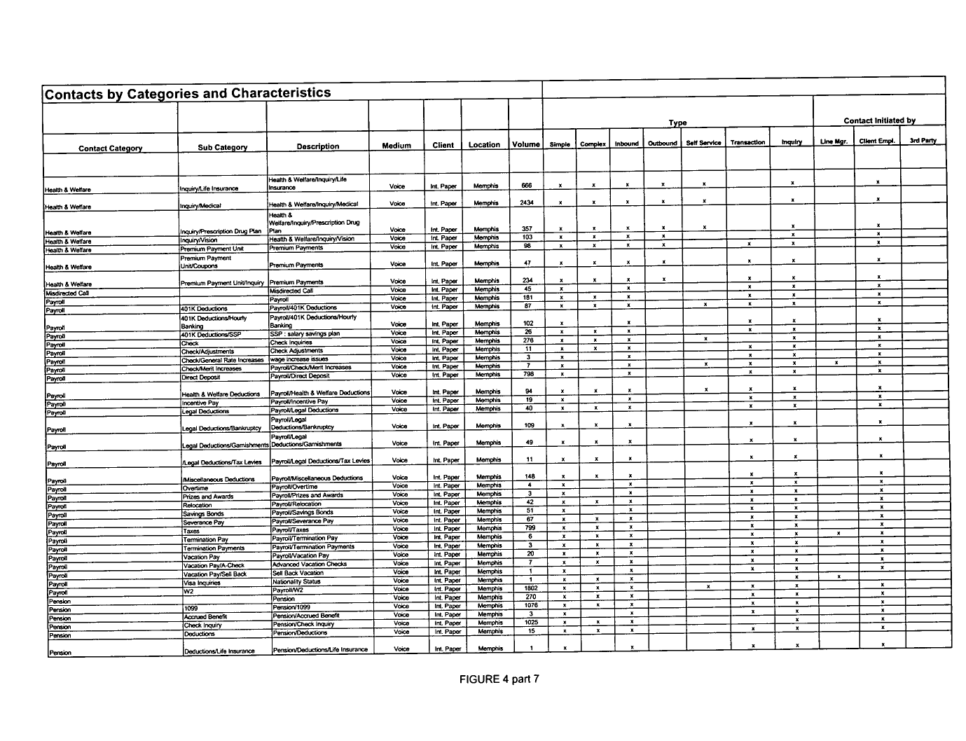

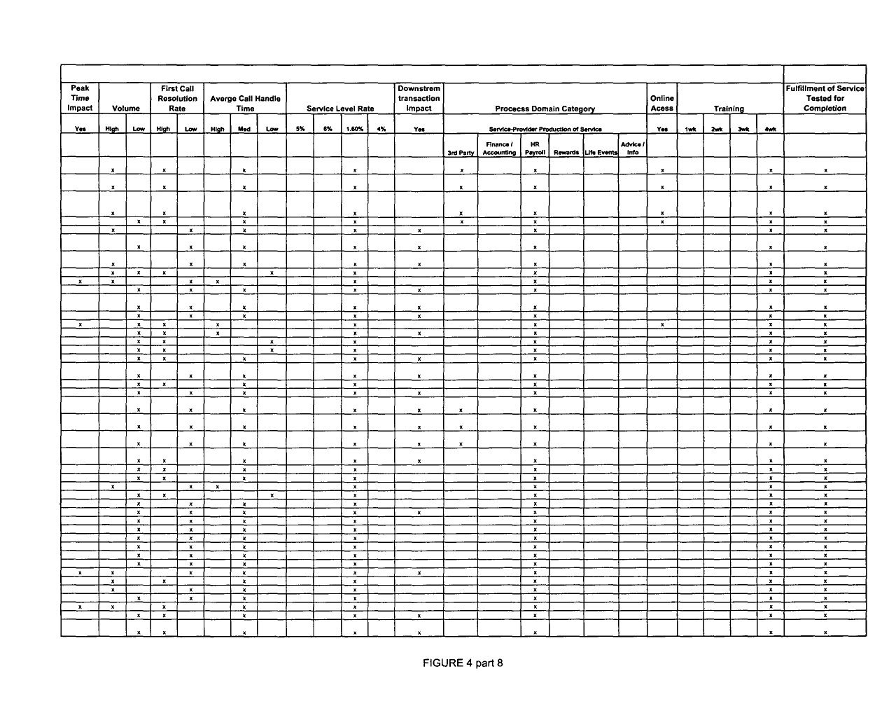

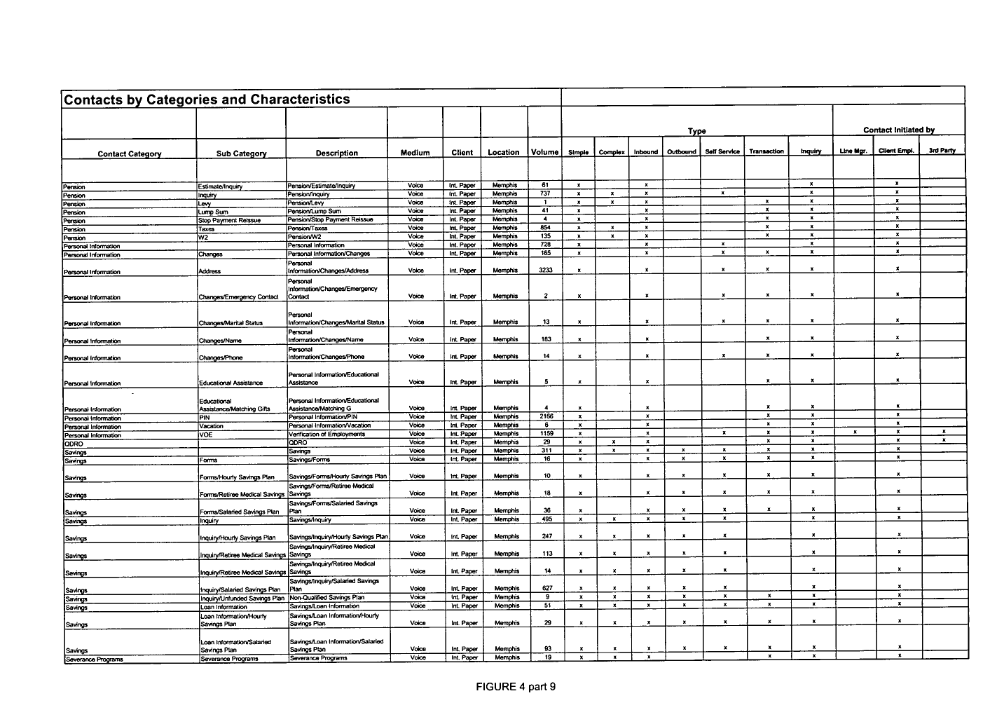

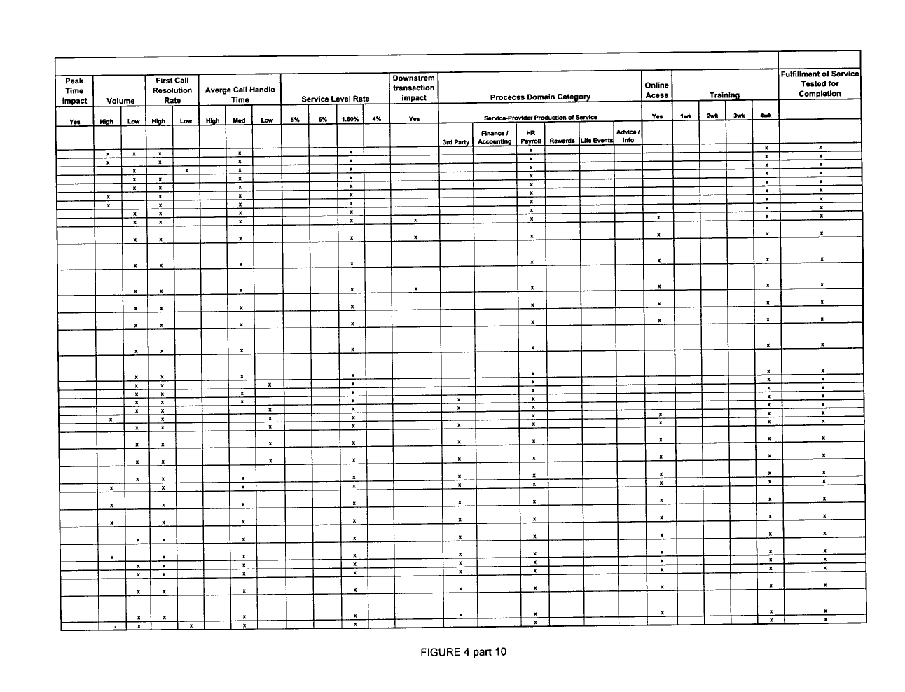

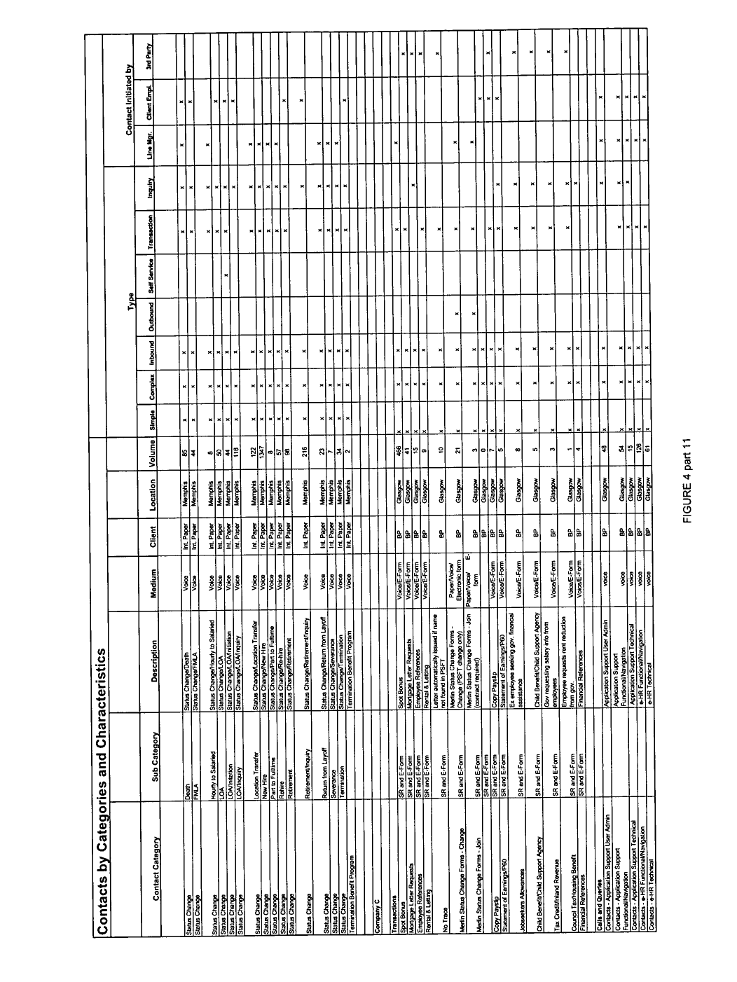

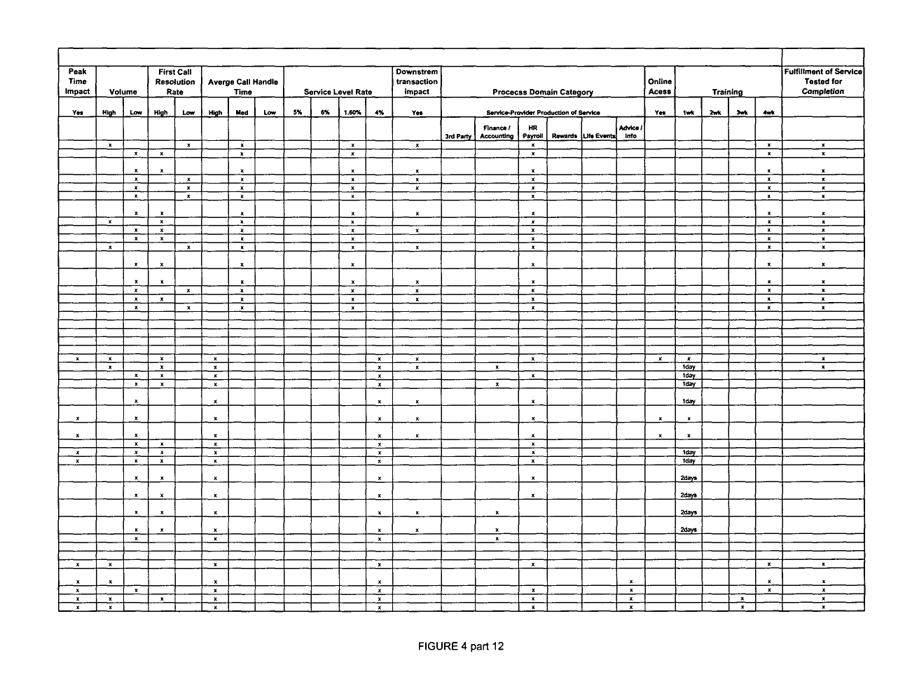

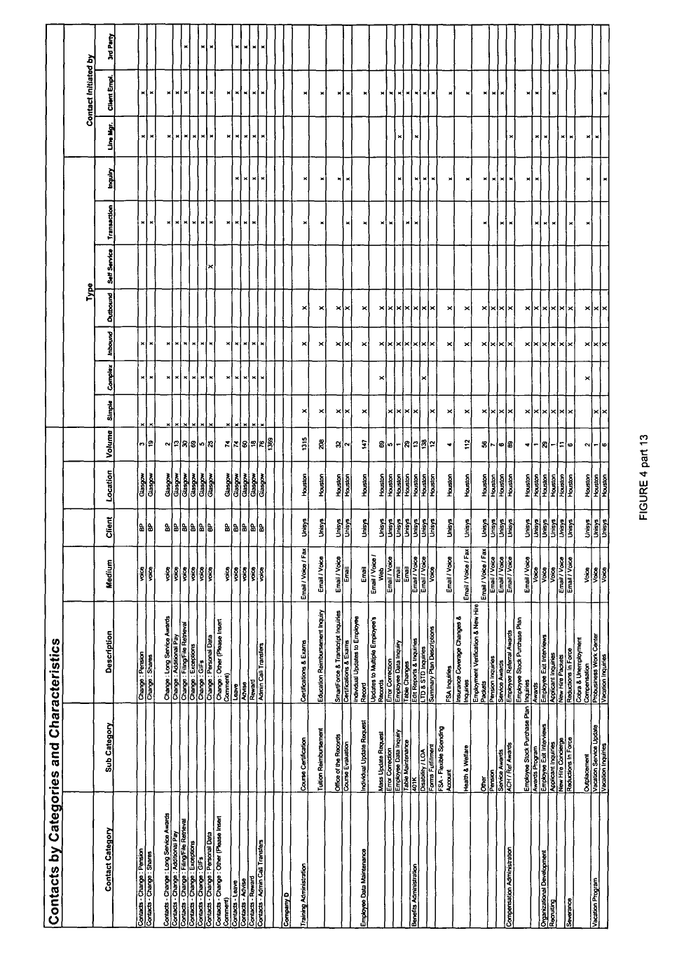

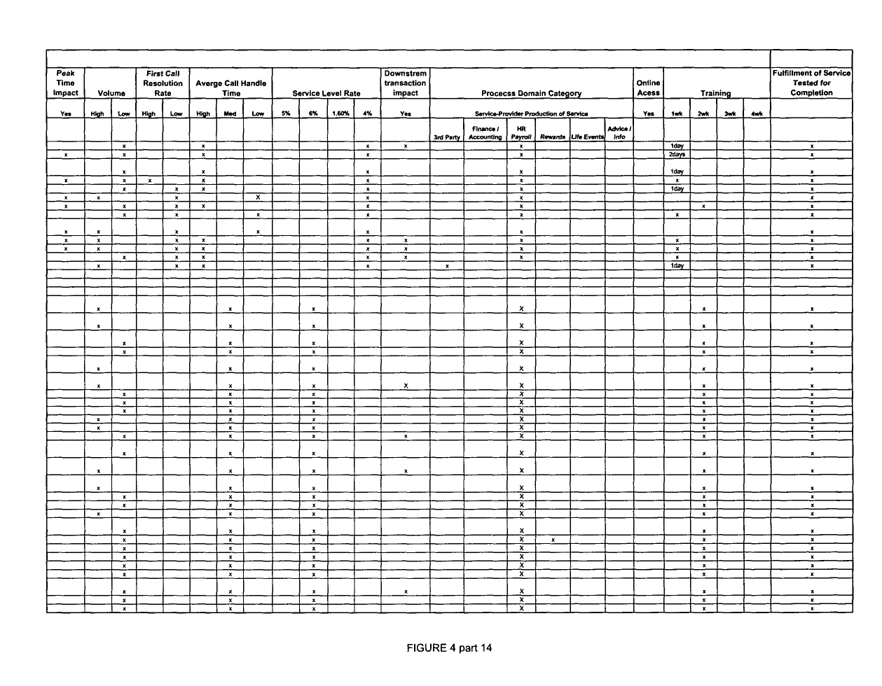

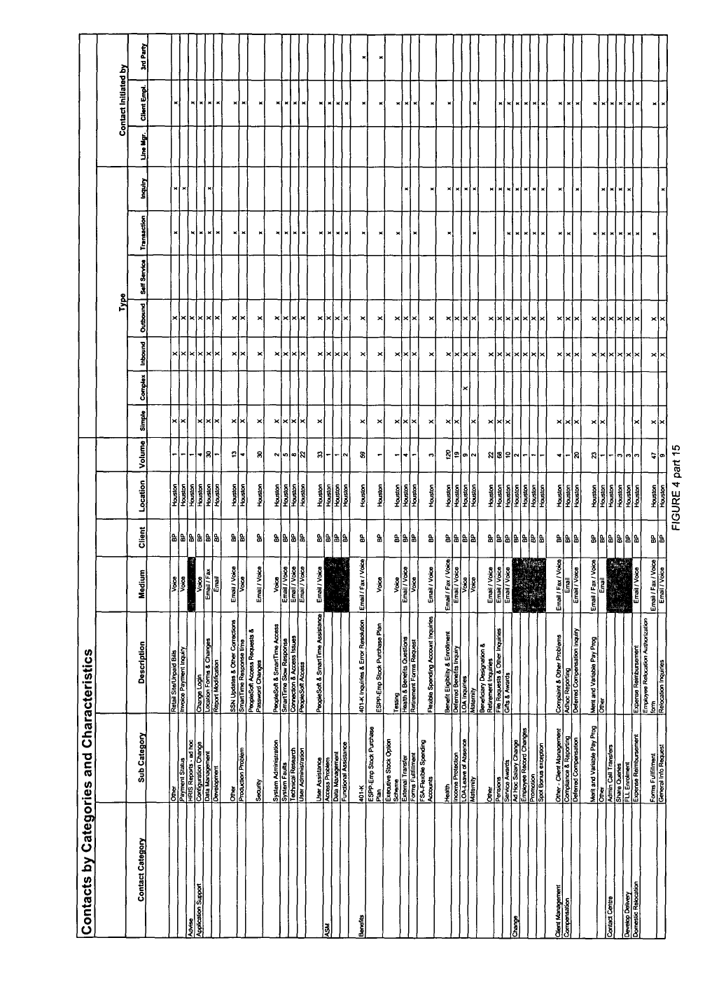

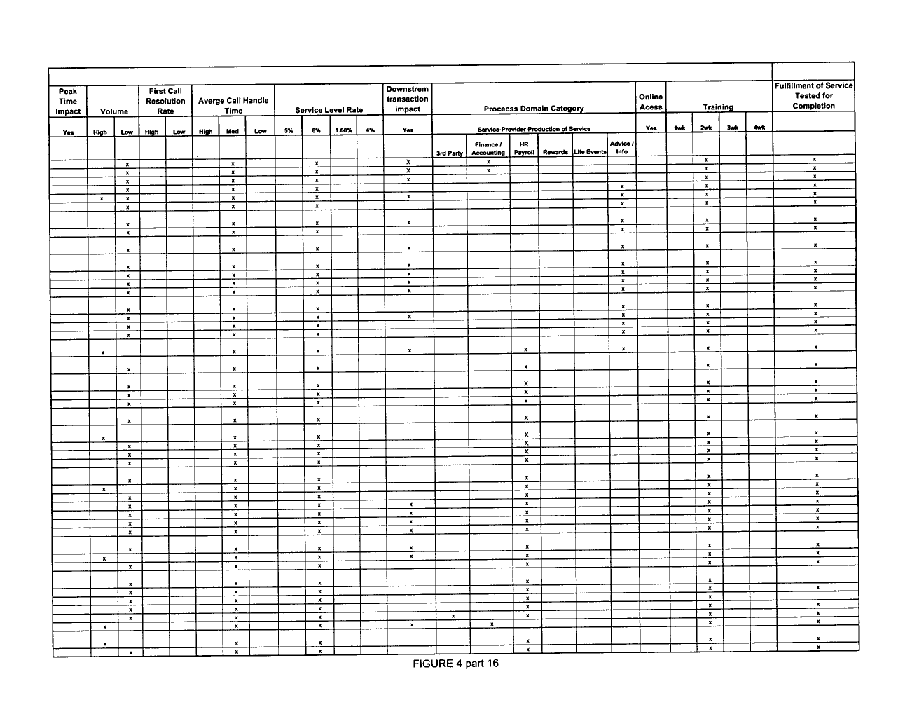

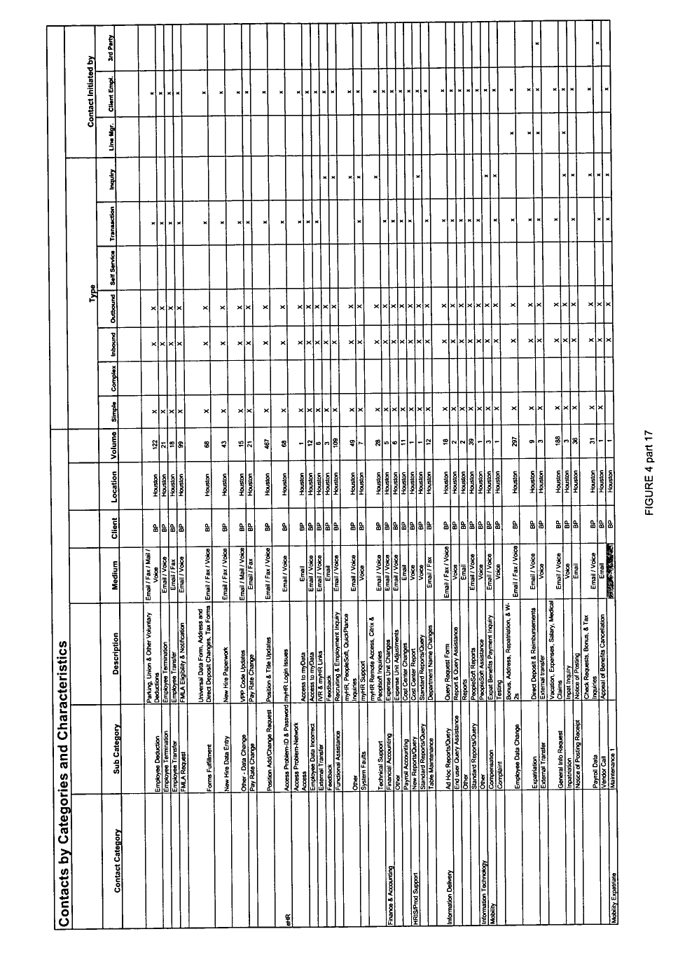

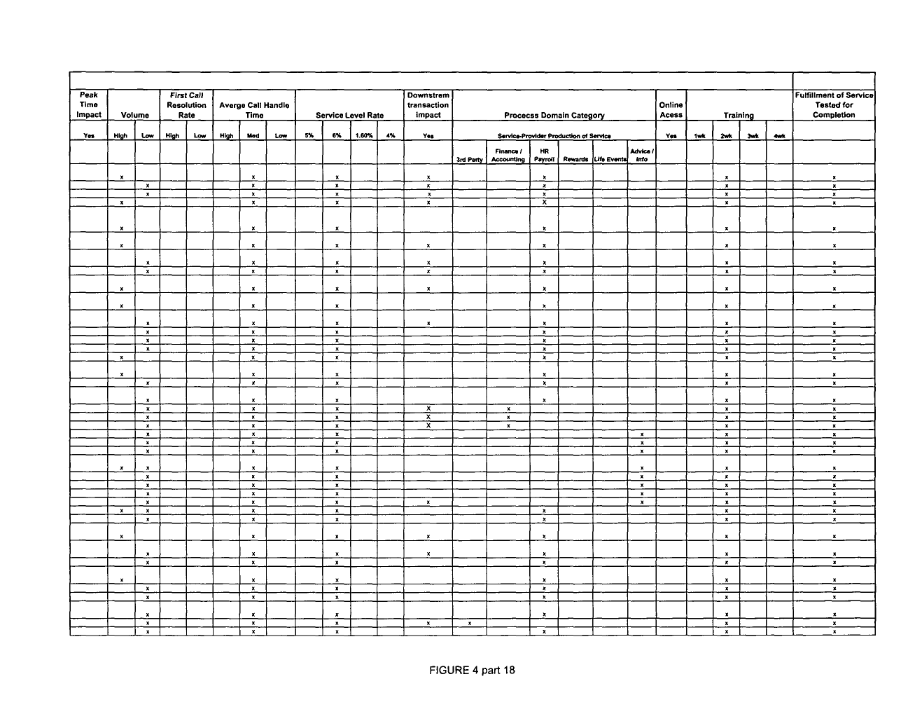

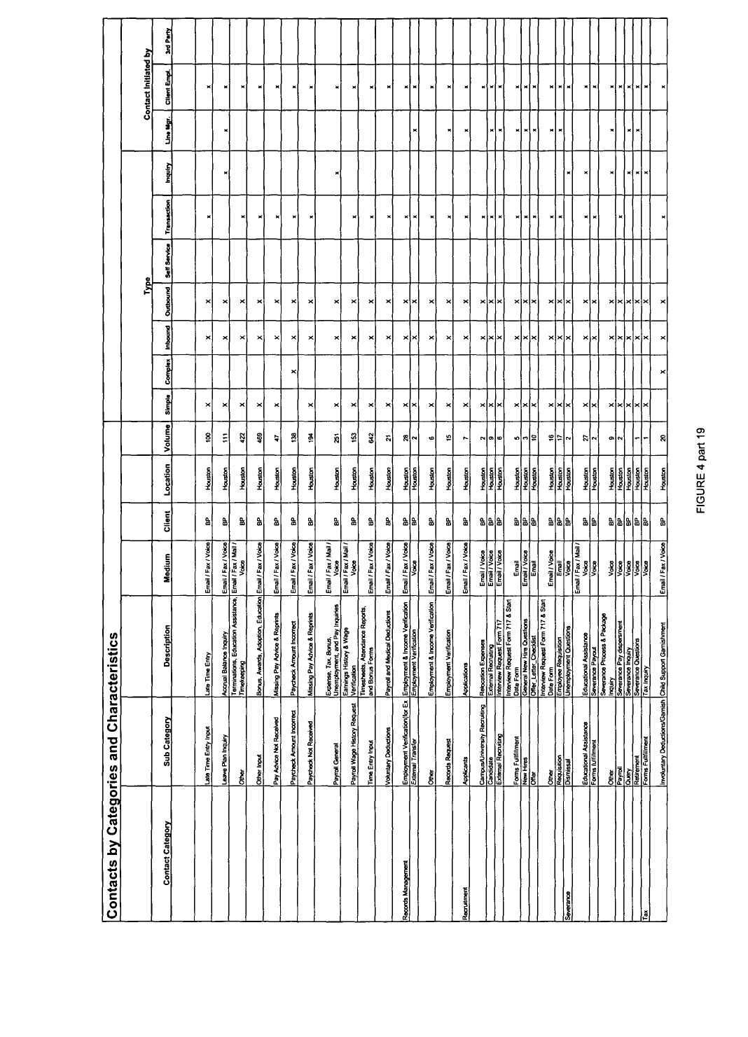

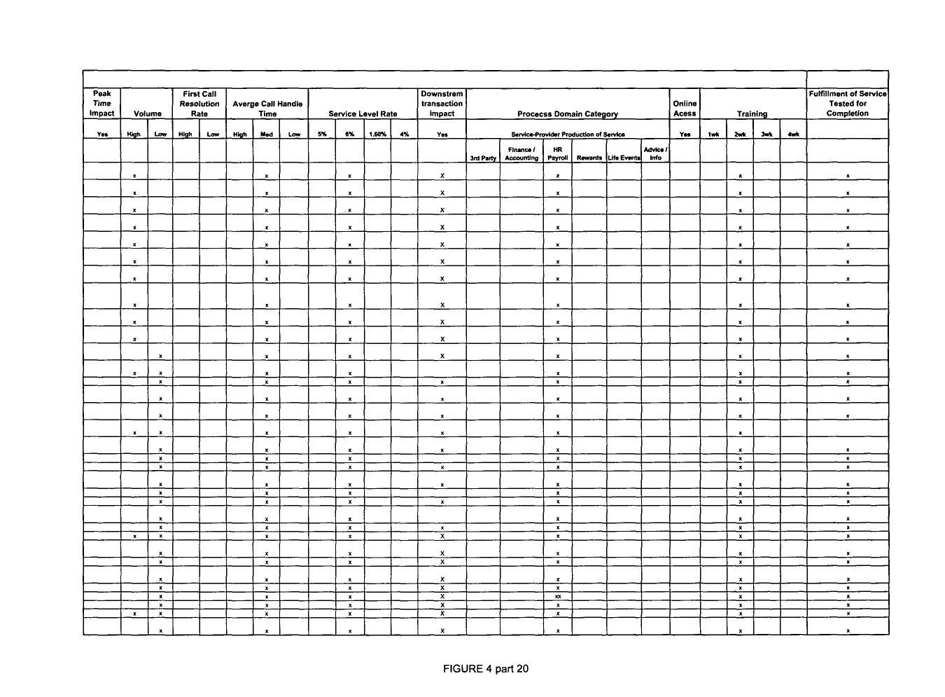

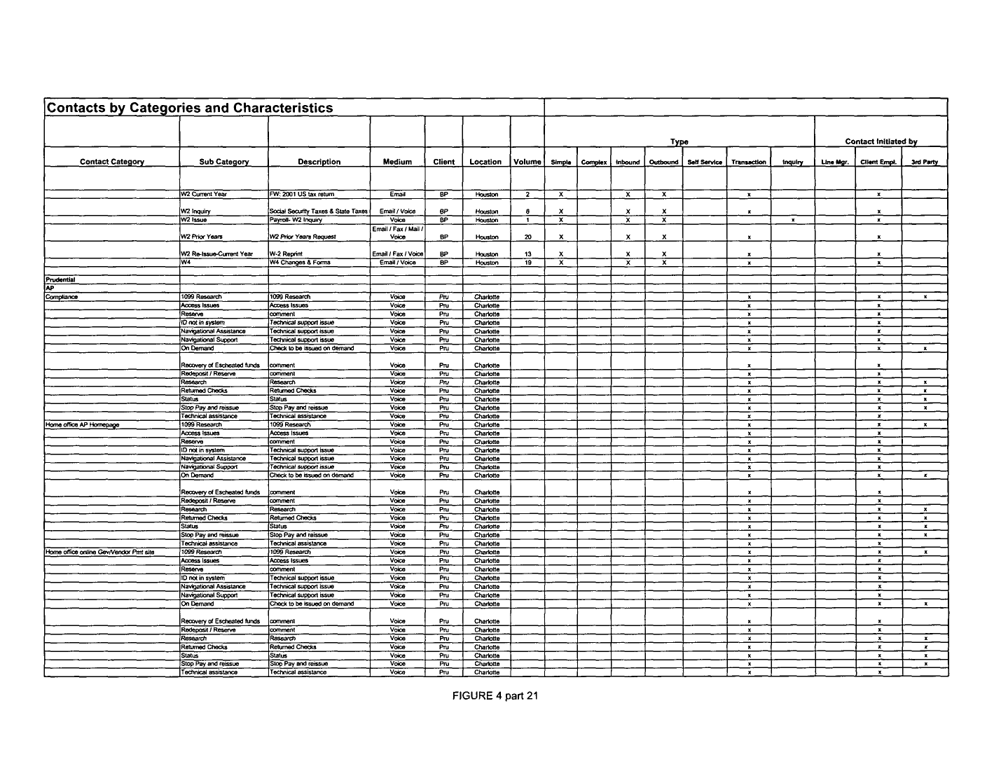

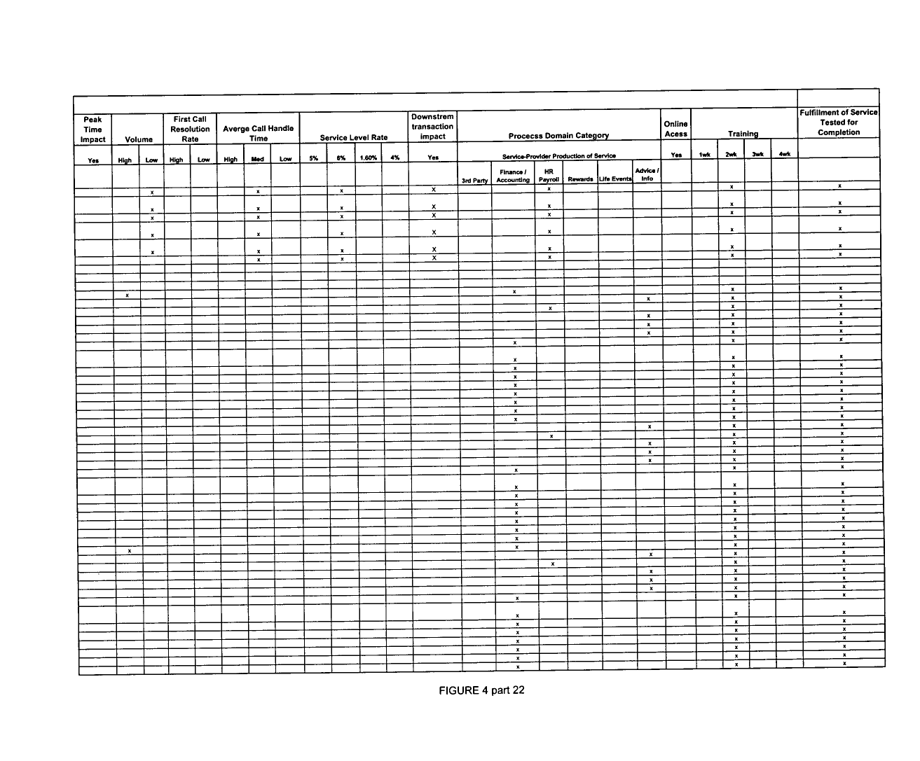

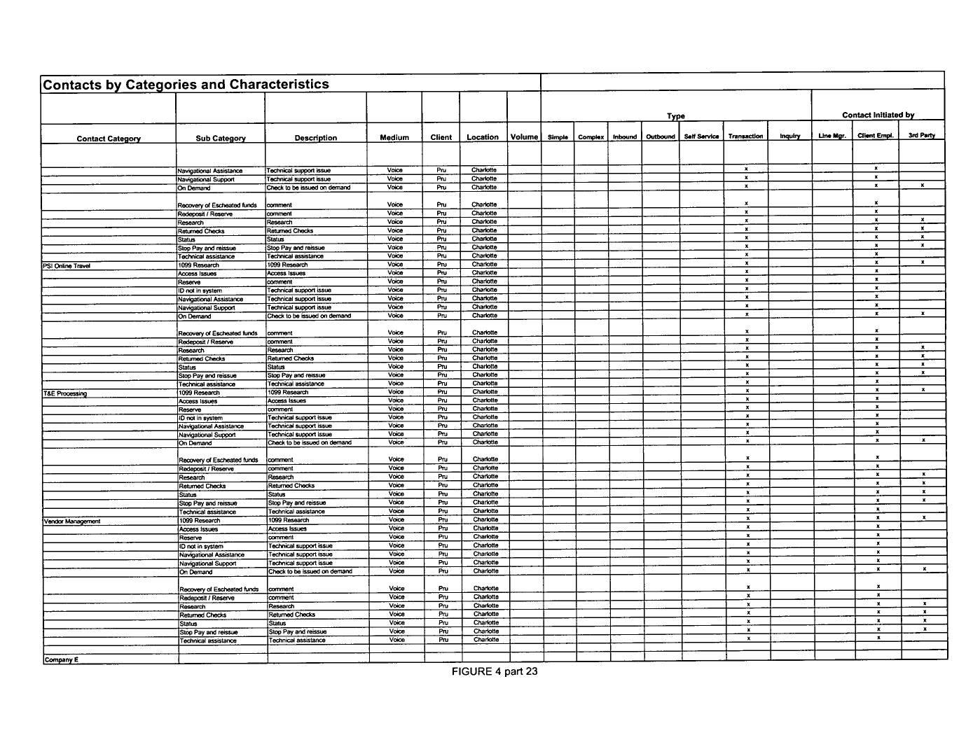

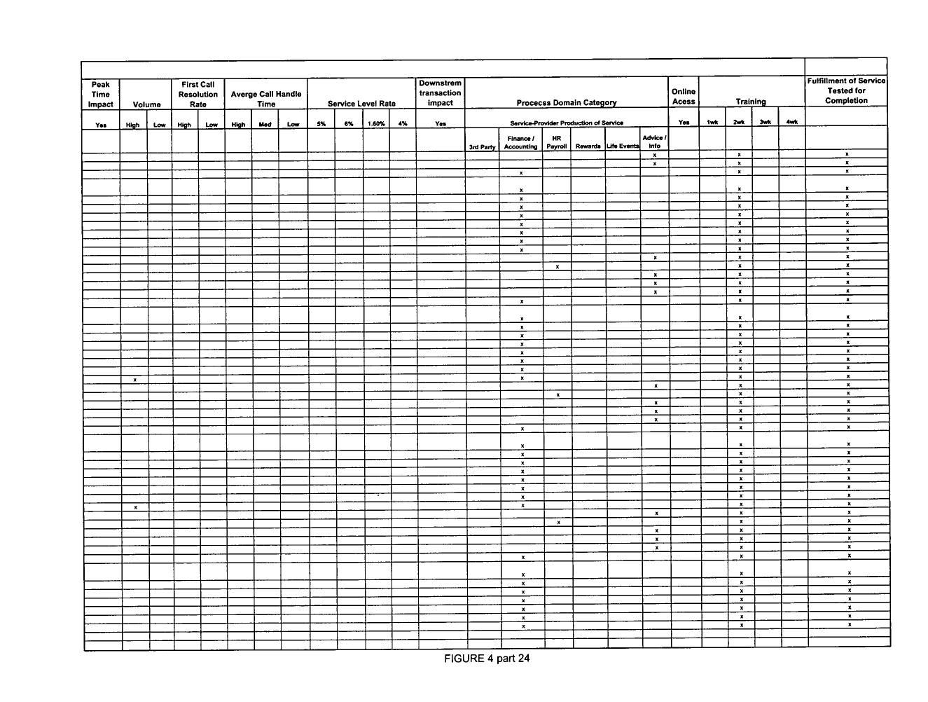

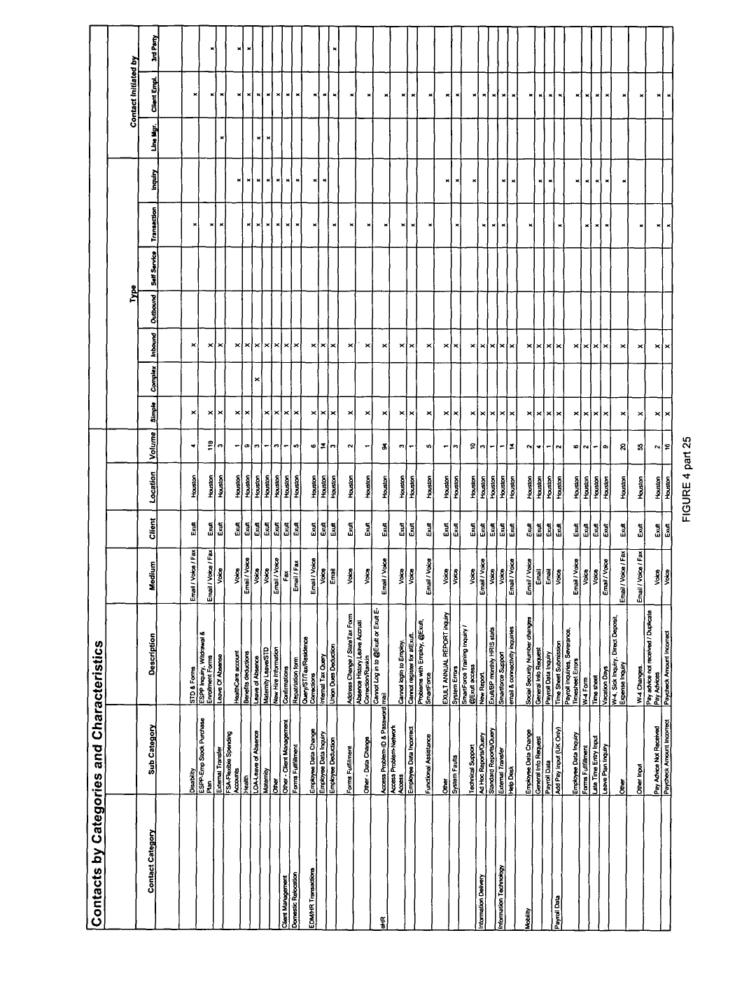

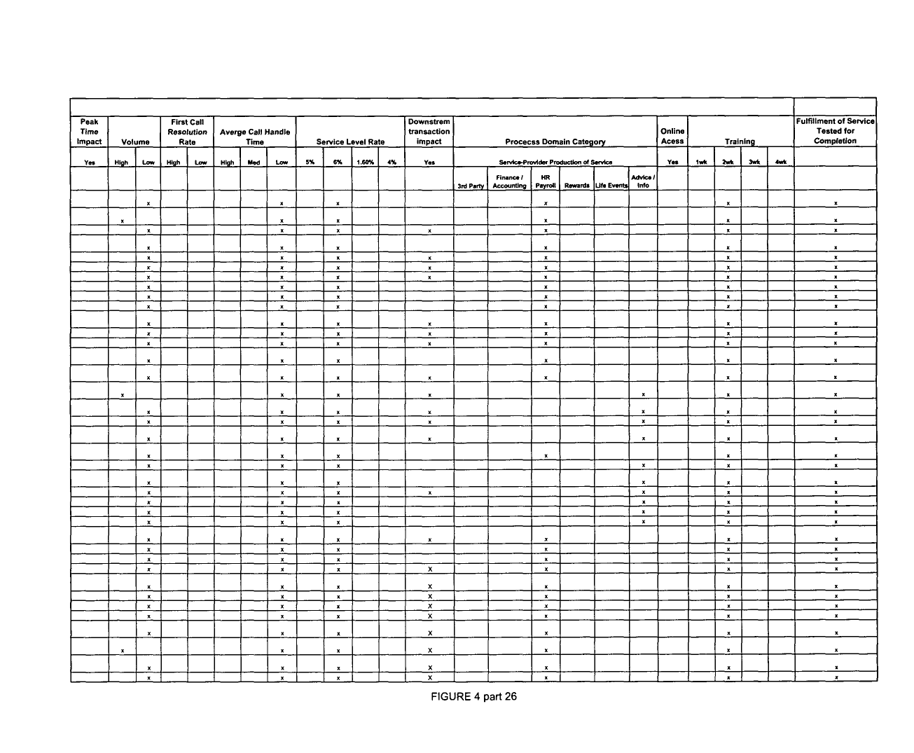

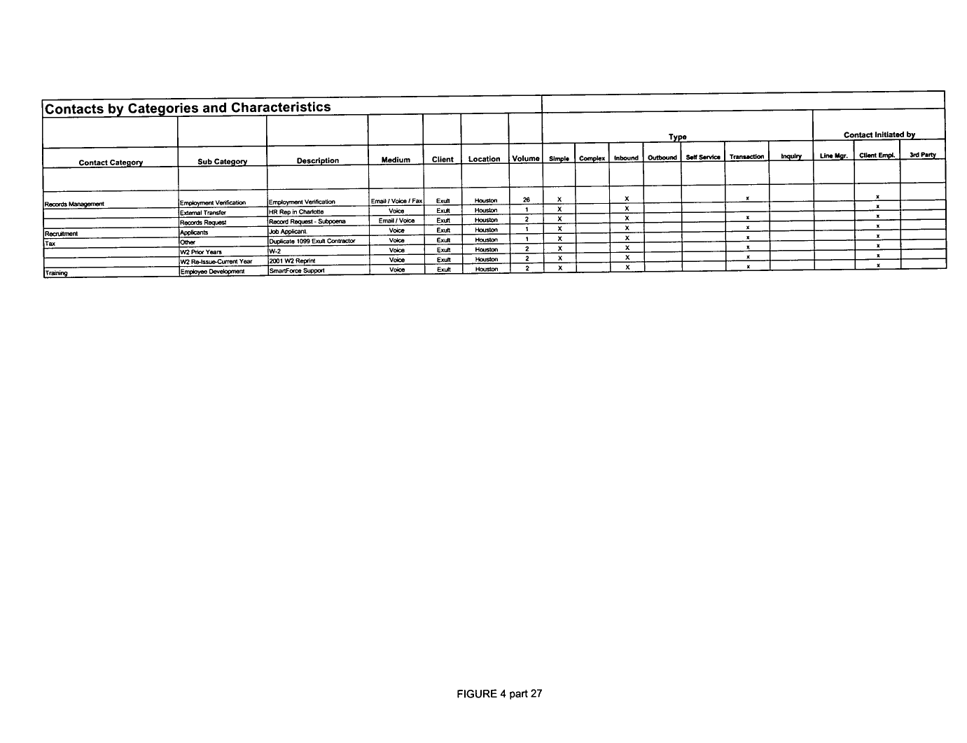

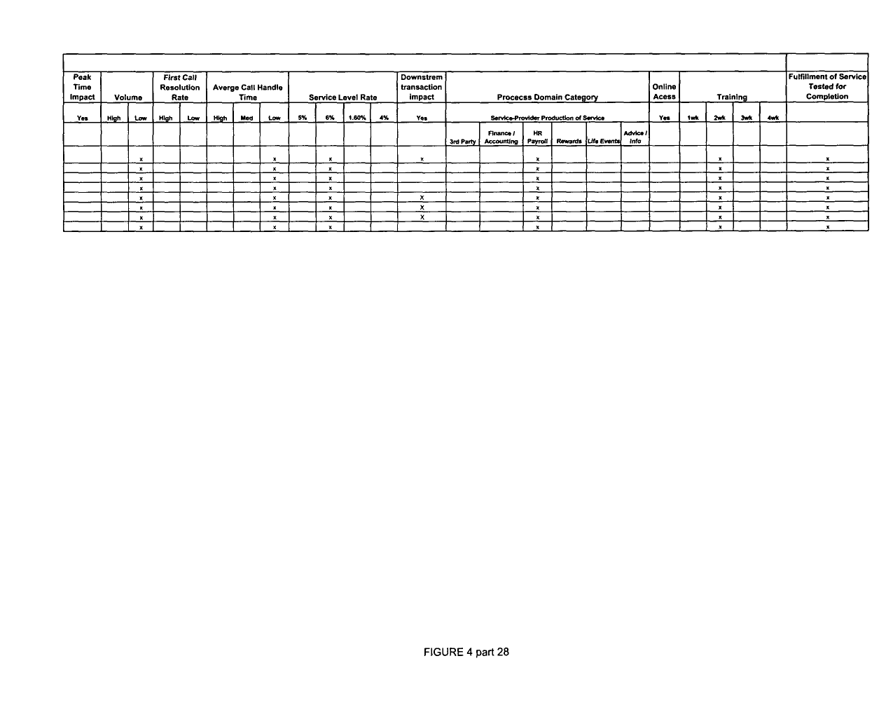

Referring now to FIG. 4, a table is shown for use with the system and method of the present invention. The table is an illustration of the one or more attributes which may be used to describe the service requested in the service request. For example: the medium on which the service request was received, the identify of the requestor, the location of the requestor, the time the request was received, the language of the requestor, the language of the request, the volume required by the request, whether the request is a simple request or a complex request, whether the request is an inquiry or a transaction, the name of the project or organization associated with the service request, whether the service request is made by a third party, and the expected or project response time to fulfill the service request.

The attributes describing service requests illustrated in FIG. 4 may be used to determine to which of the plurality of service-providing nodes 200 a service request should be transmitted. For example, a service request for “payment invoice” may comprise attributes related to “amount”, “client”, and “inquiry”. The “amount” attribute may record the amount of the invoice, the “client” attribute may record the name of the client to whom the invoice was sent, and the “inquiry” attribute may record whether the service request is a new invoice or merely an inquiry about a previous invoice. In this example, the service request could be an inquiry about the amount of a previous invoice sent to a particular client; based on the values of these attributes, the service request would be transmitted to the service-providing node 200 responsible for storing information related to invoices sent to that particular client, e.g. “the accounting department.”

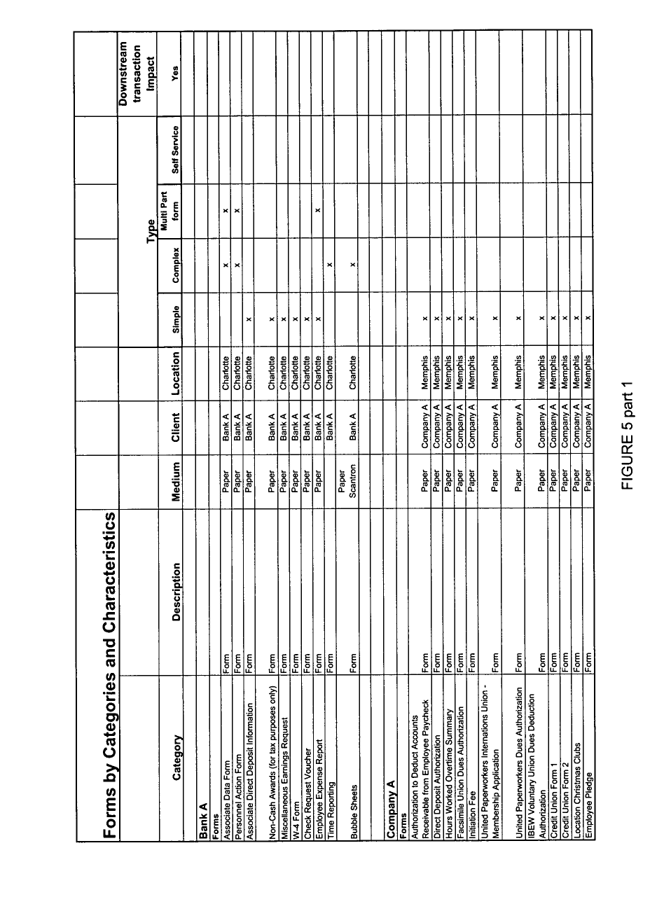

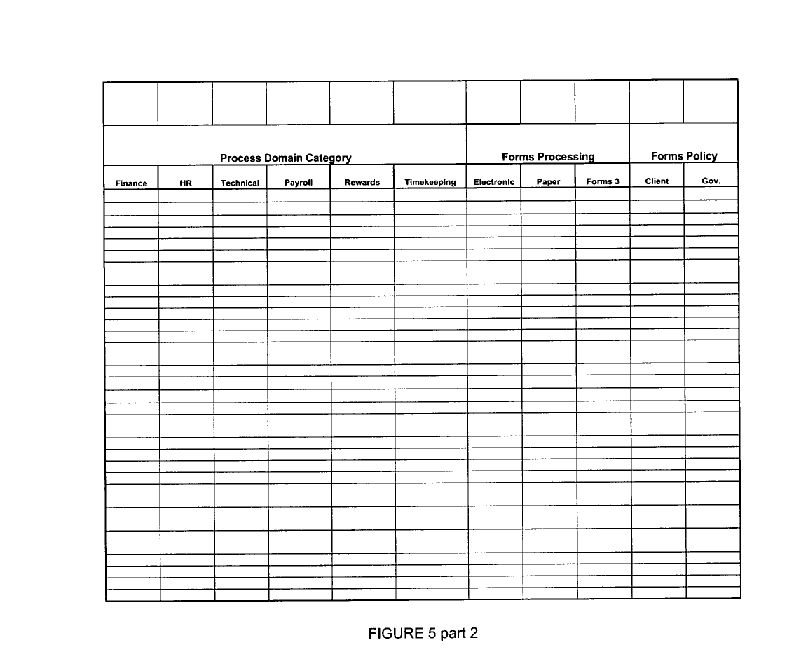

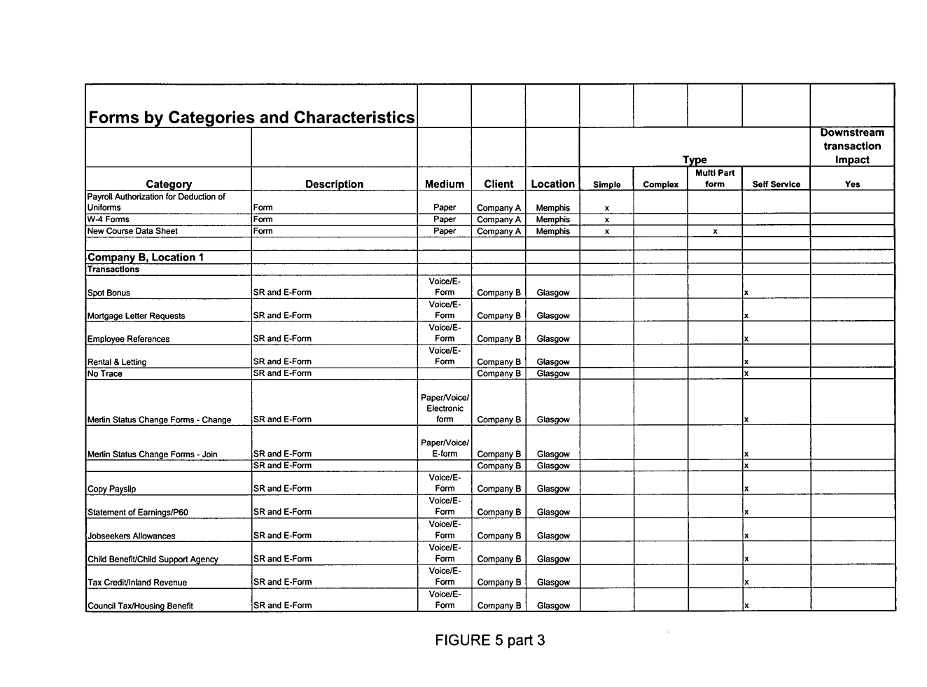

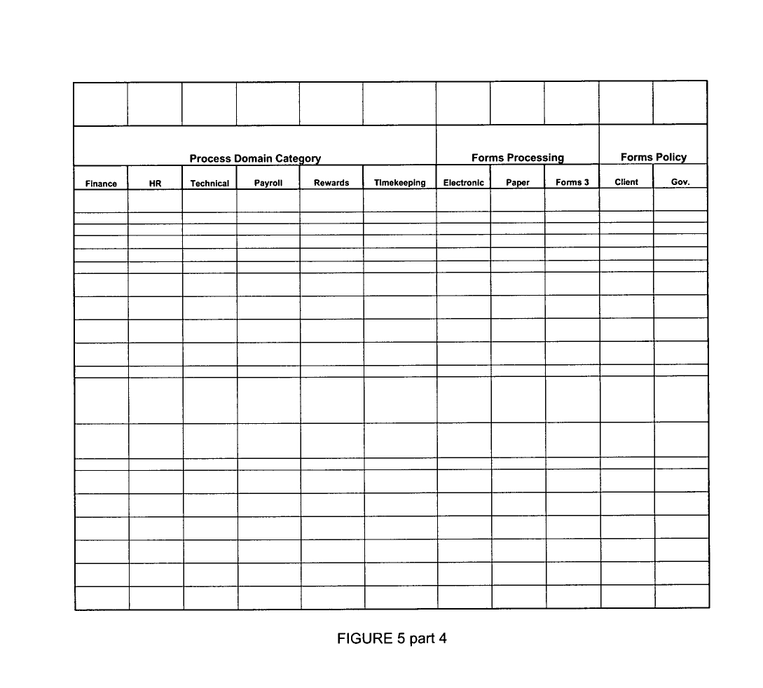

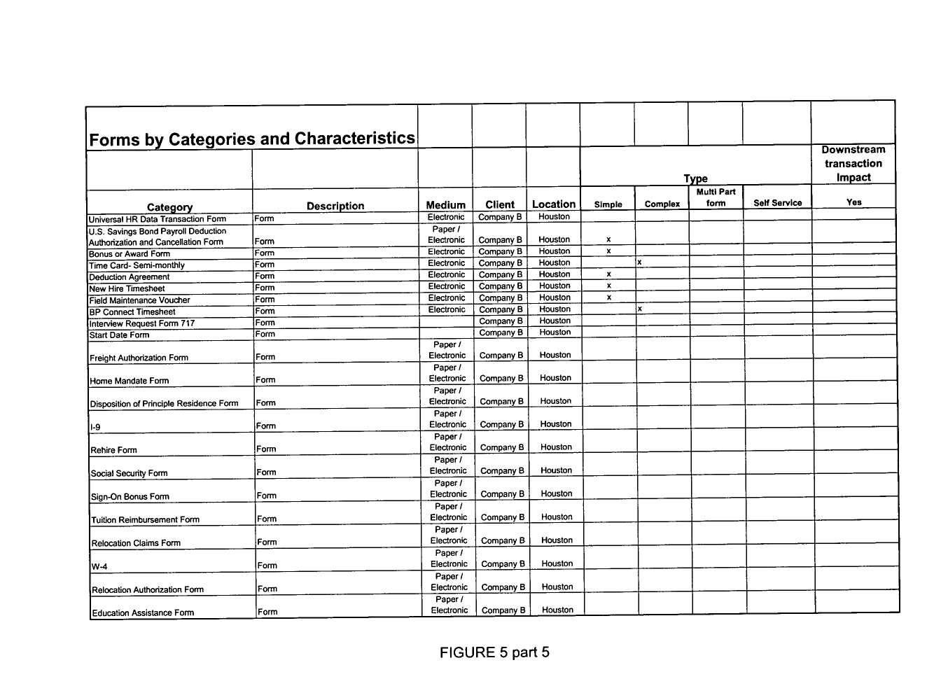

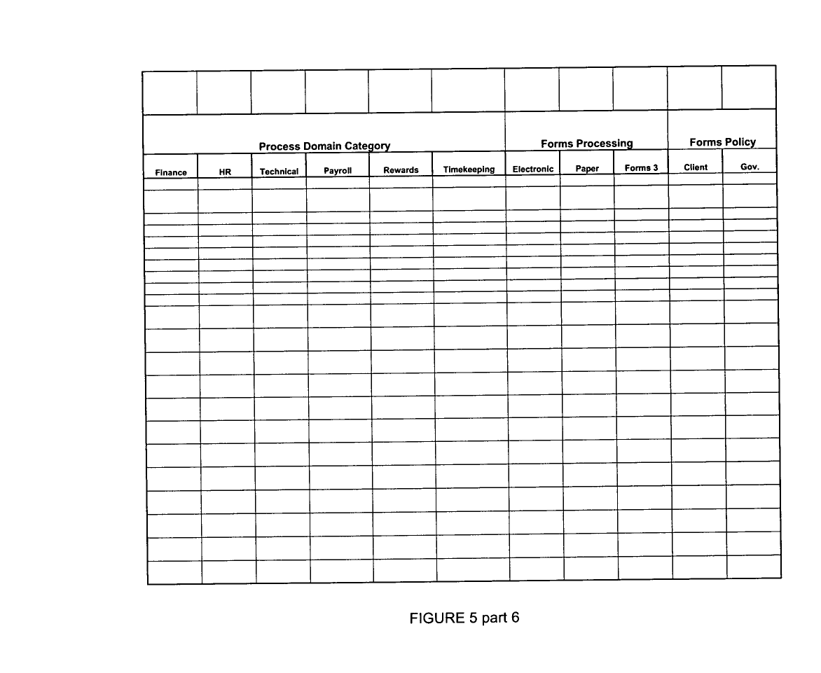

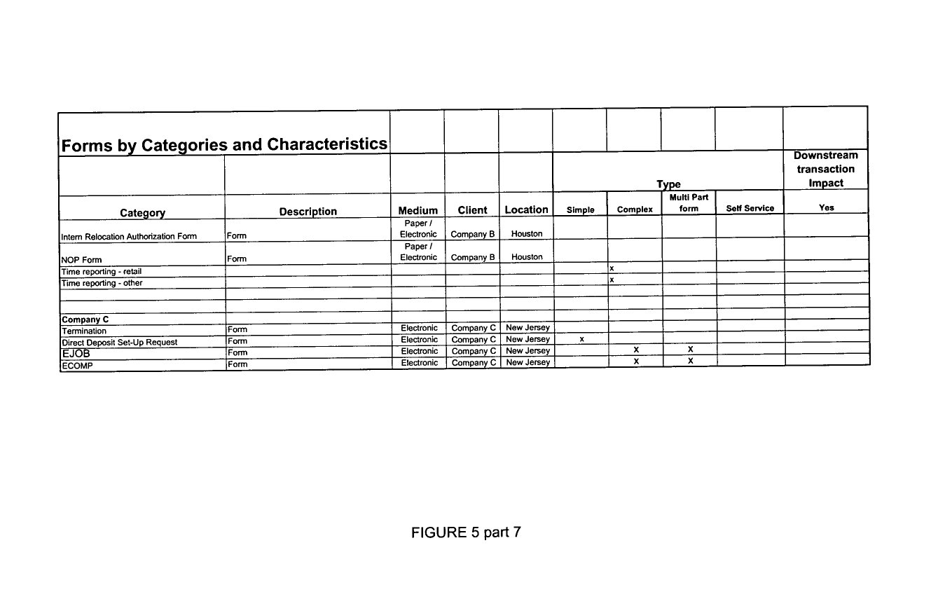

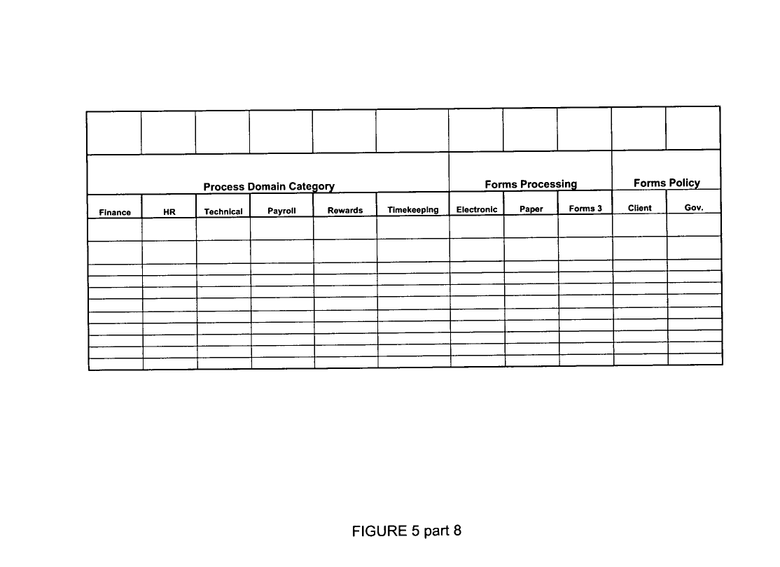

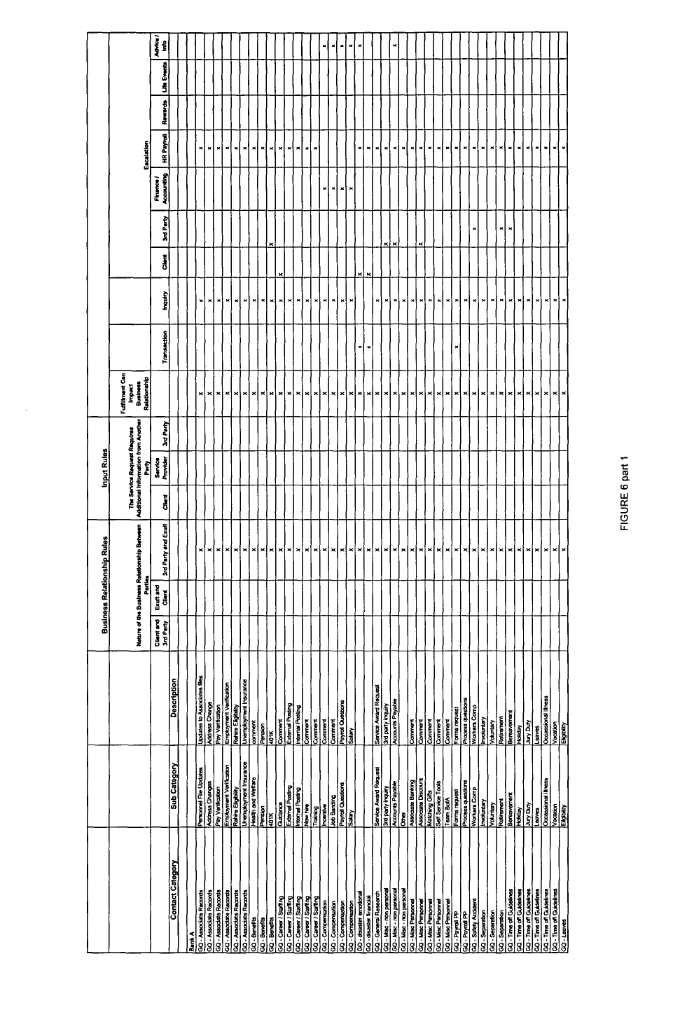

Referring now to FIG. 5, there is shown a second table constructed in accordance with the principles of the present invention. The table illustrates how attributes may be used to describe the request itself; i.e. the form of the service request. For example, the attributes may indicate the medium of the service request (for example, “paper”, “electronic”, “telephone”, “voice”, or “electronic mail”), the location of the requestor 100, and whether the service request is “simple”, “complex”, or “multi-part”. The values of these attributes may assist in determining to which of the plurality of service-providing nodes 200 the service request should be transmitted. For example, a service request having the medium attribute “paper”, the location attribute “Memphis”, and the simple attribute “x” (indicating that the service request is of type simple) may be transmitted to a service-providing node 200 having a location in Memphis. This transmission decision may be based on the values of the attributes describing the service request.

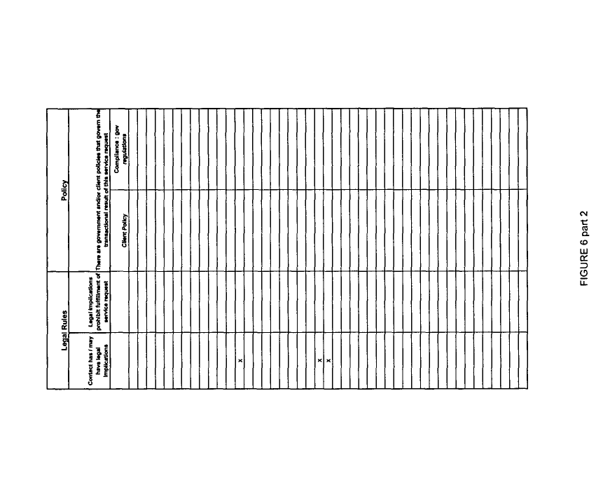

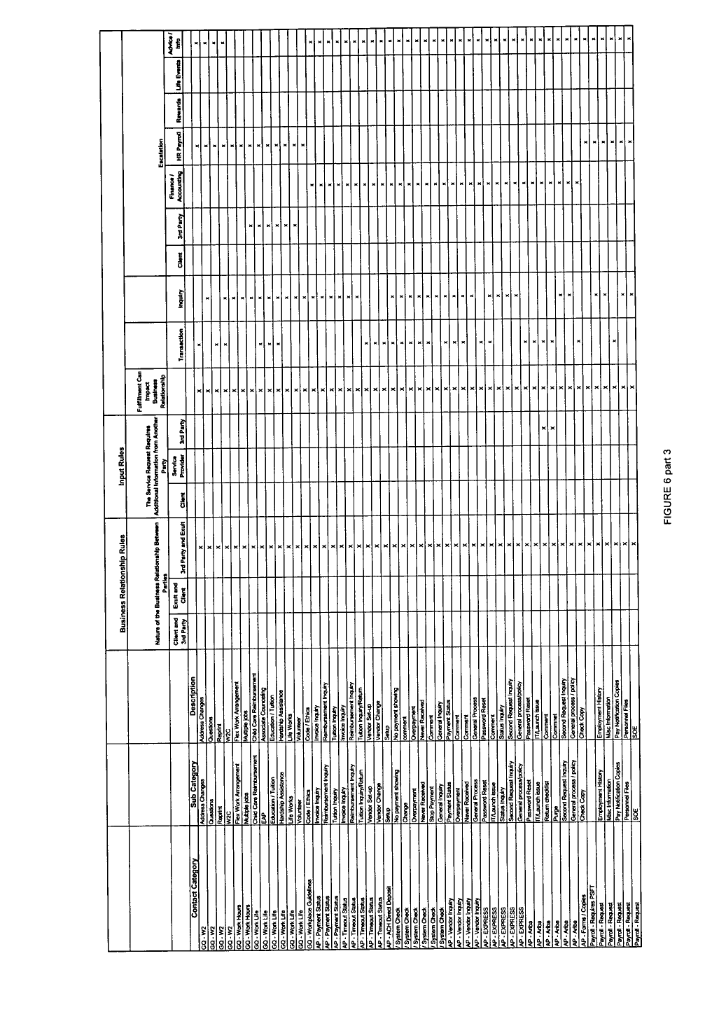

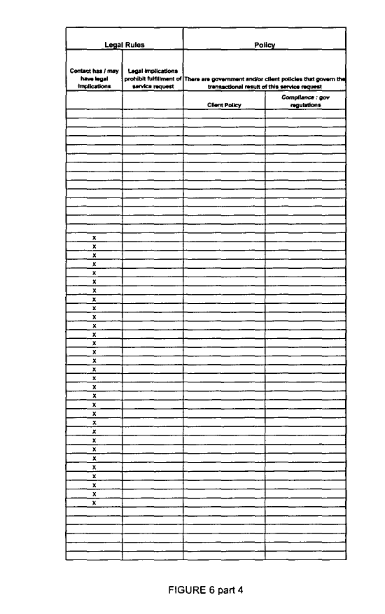

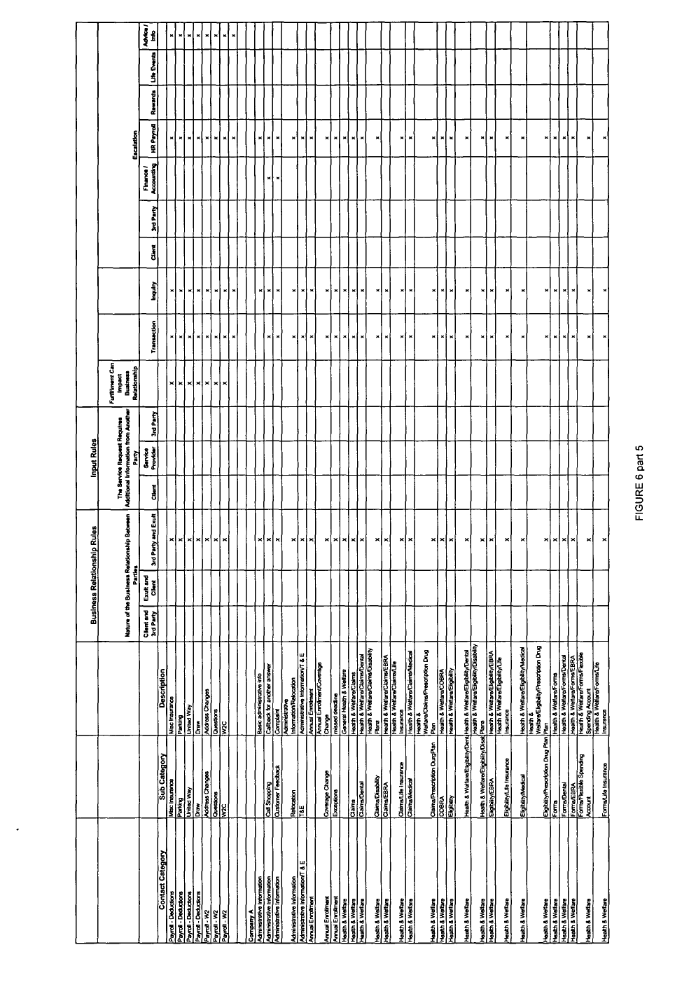

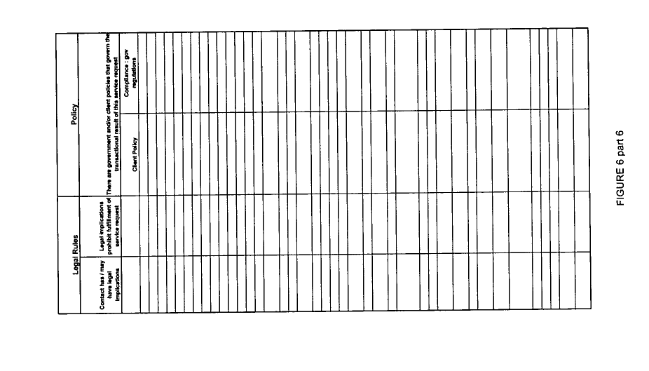

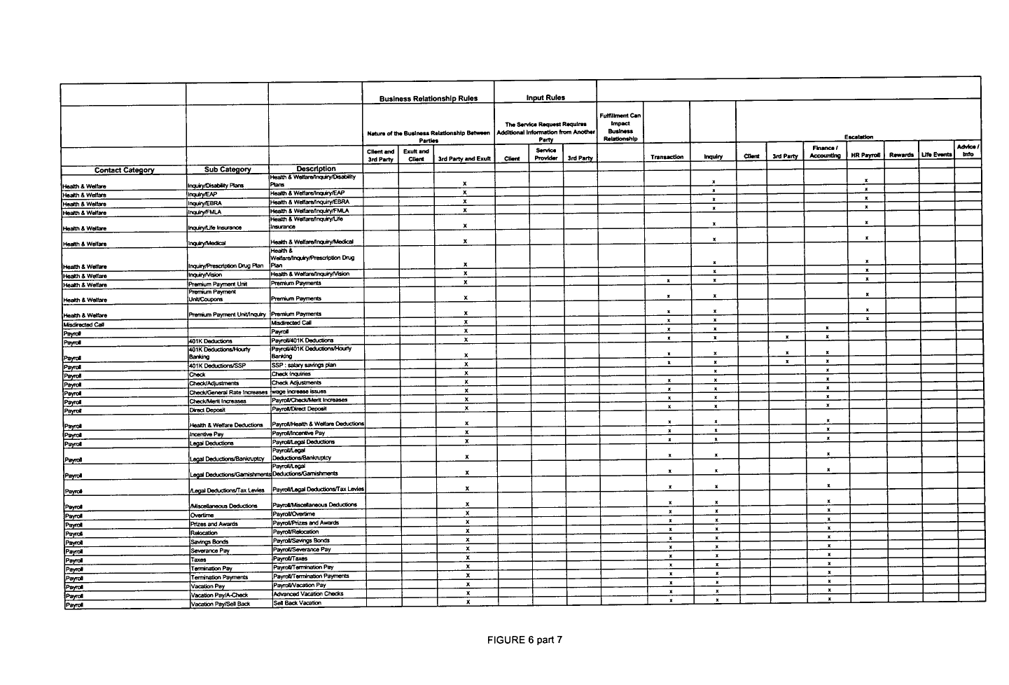

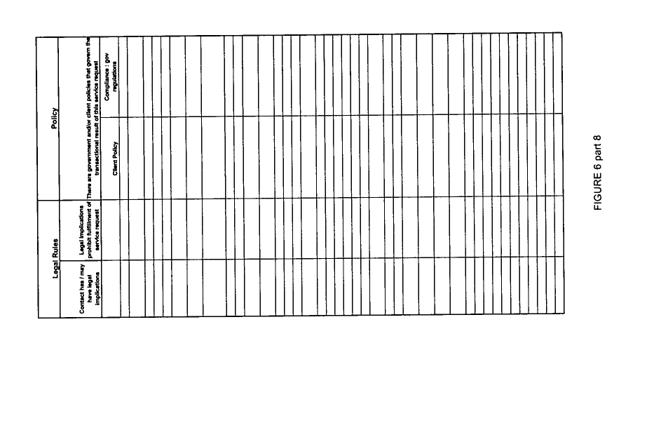

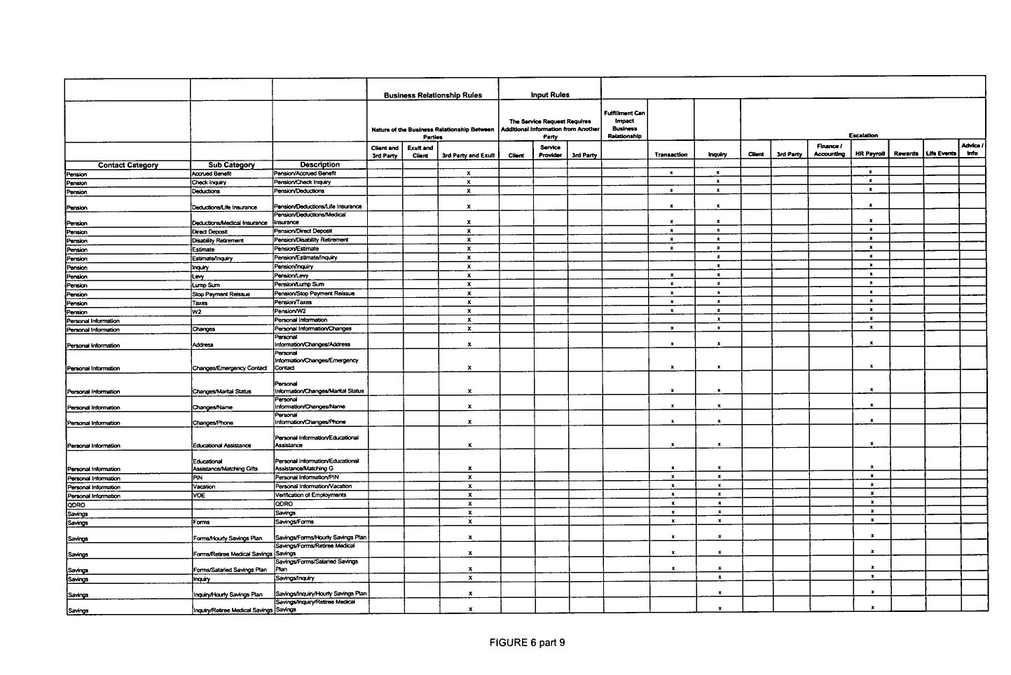

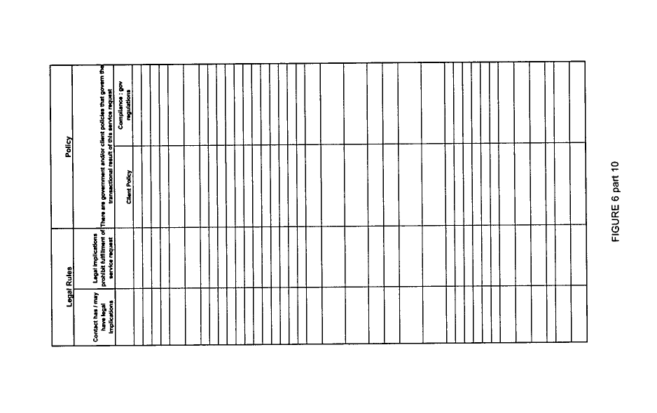

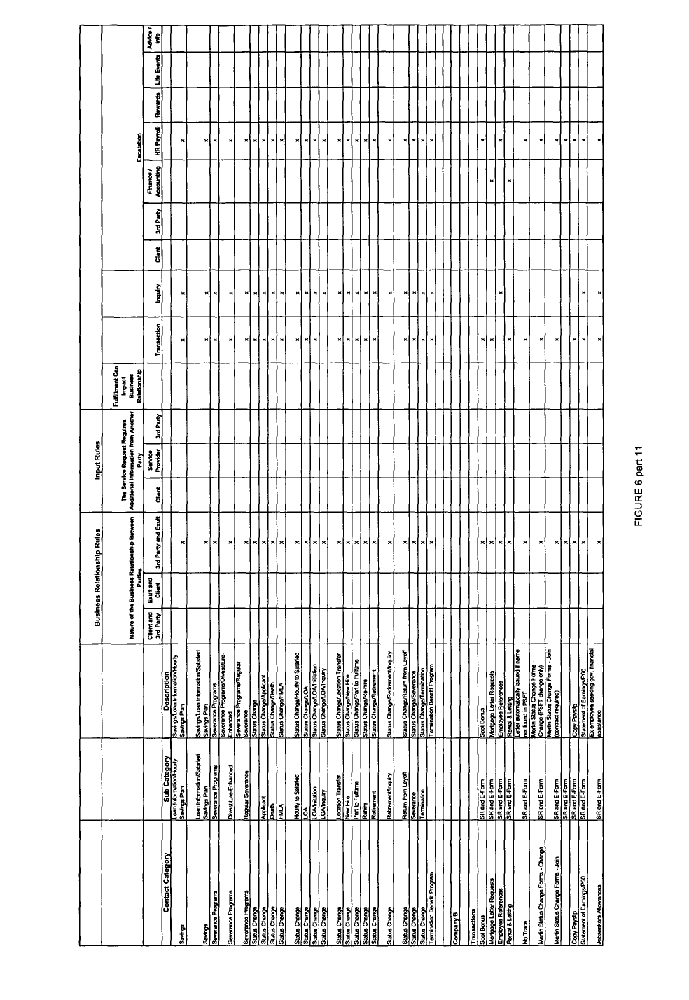

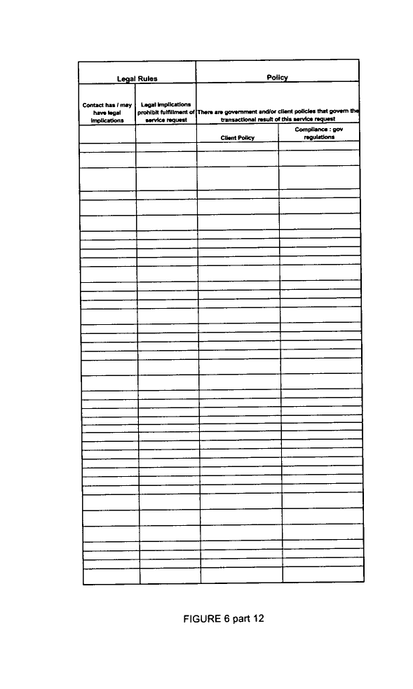

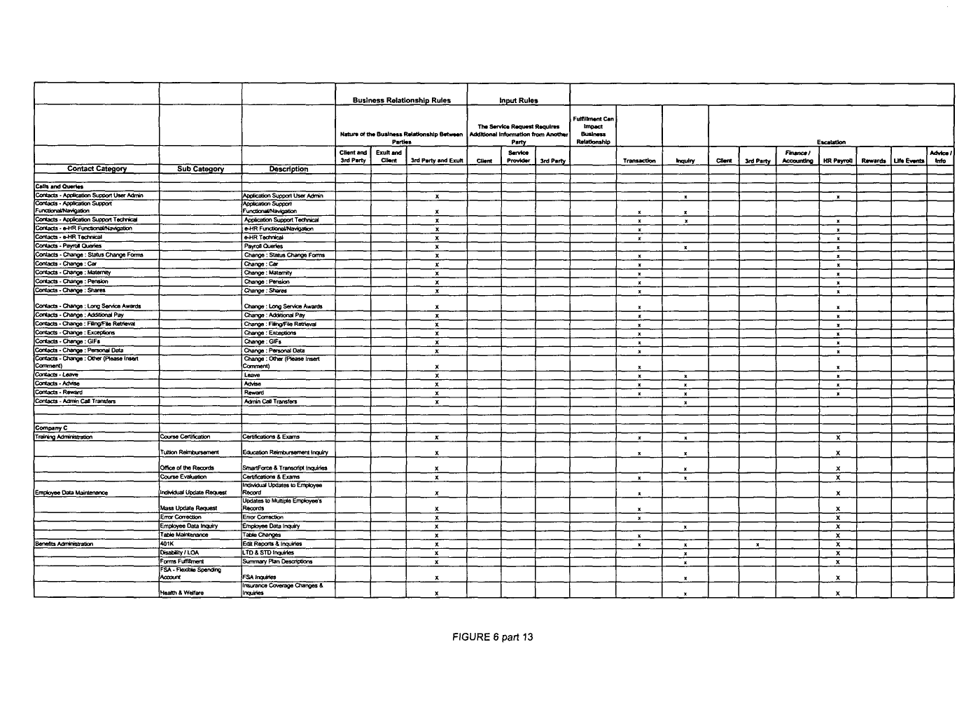

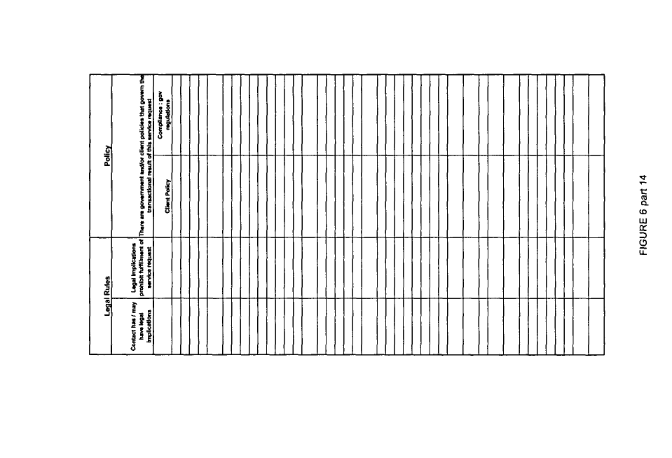

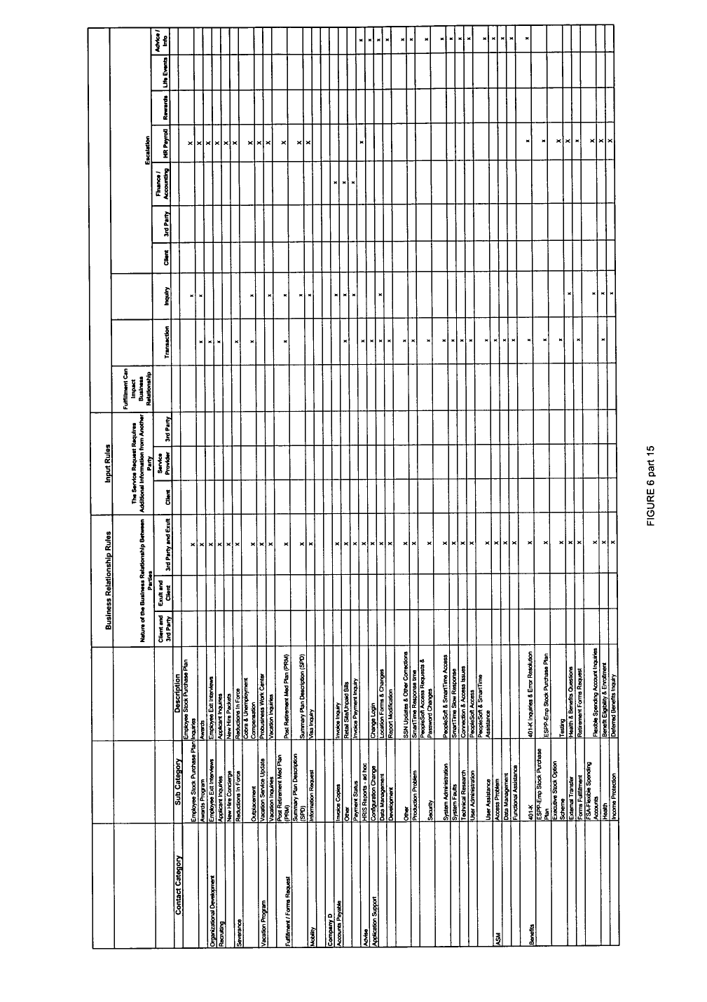

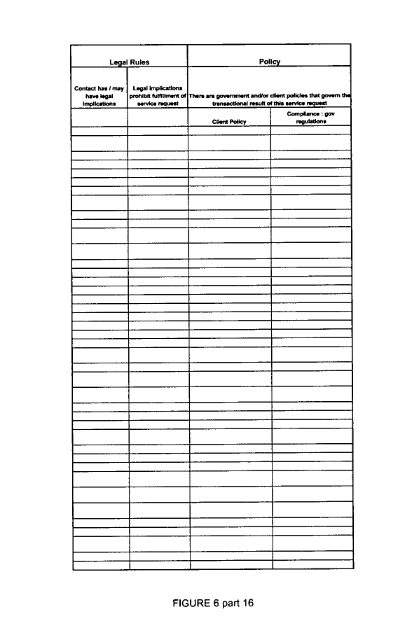

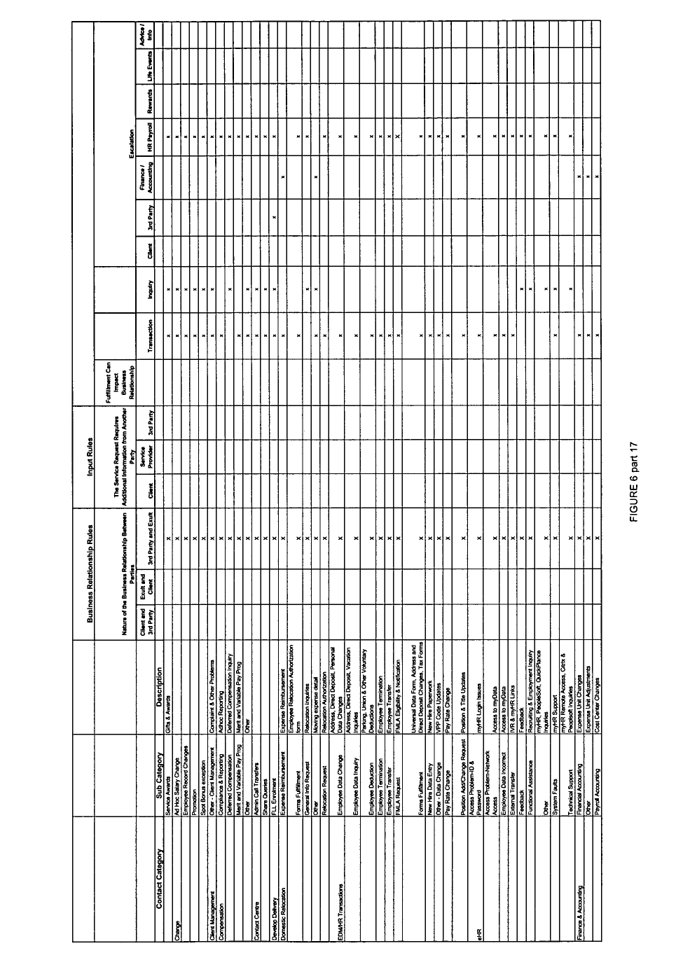

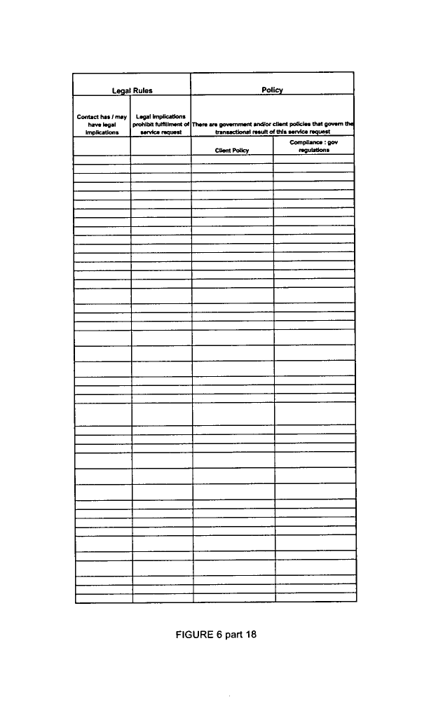

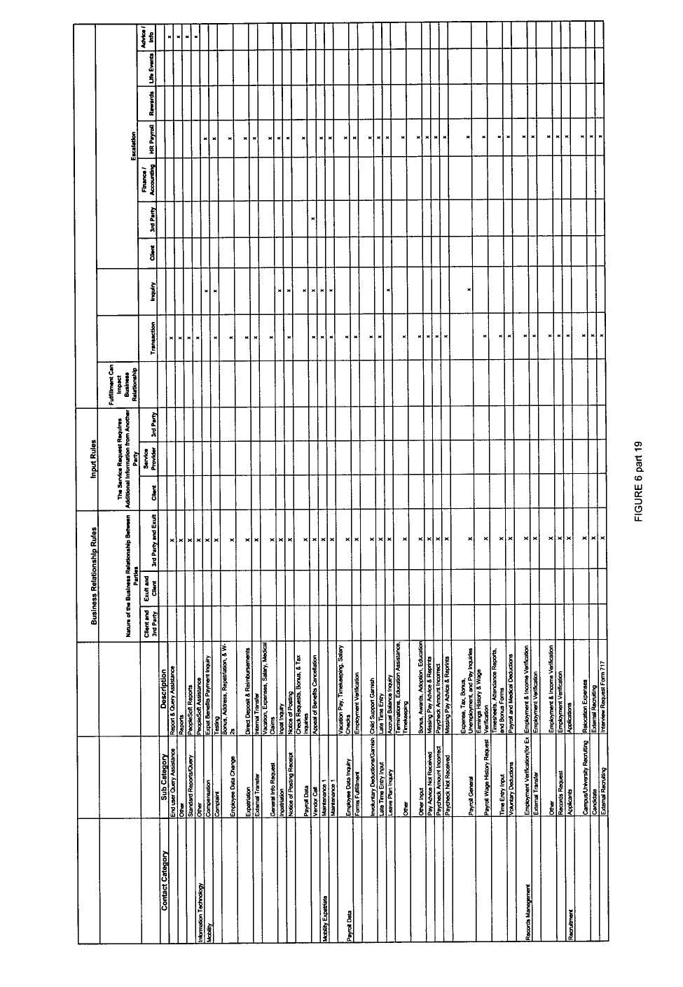

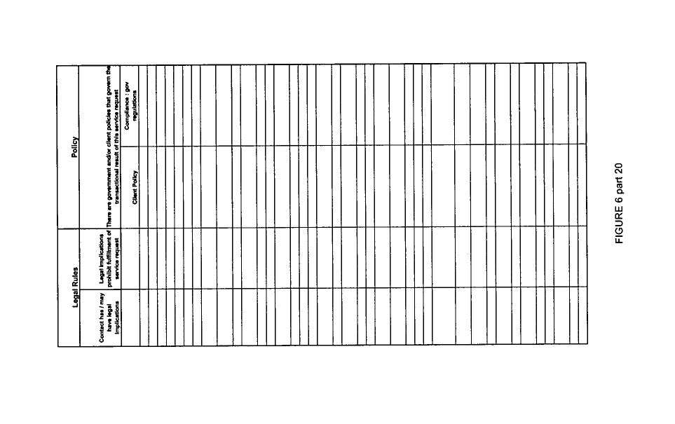

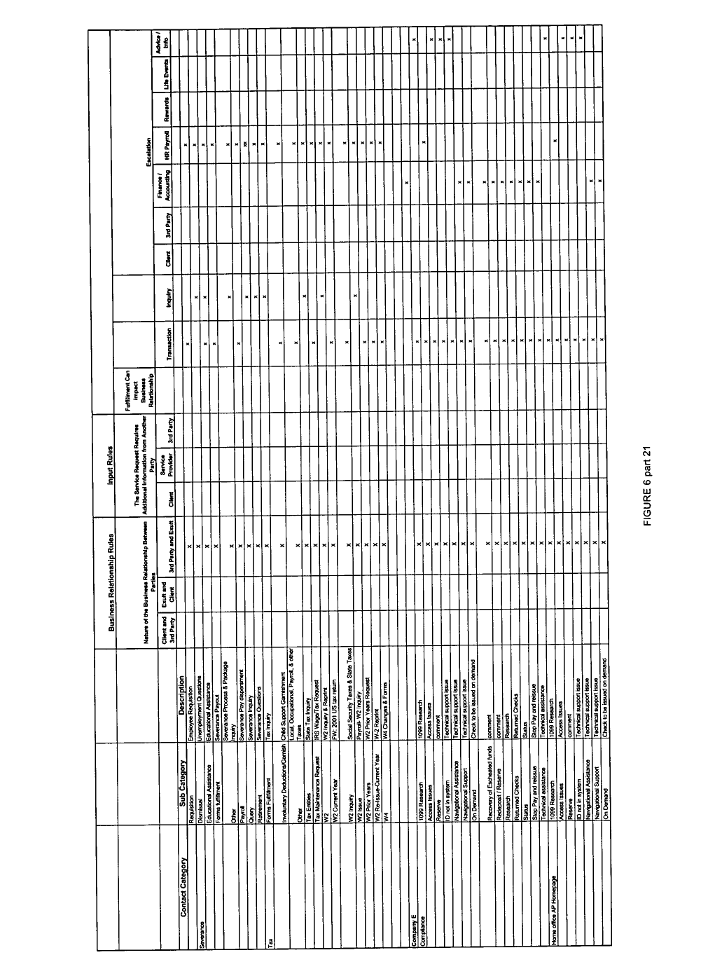

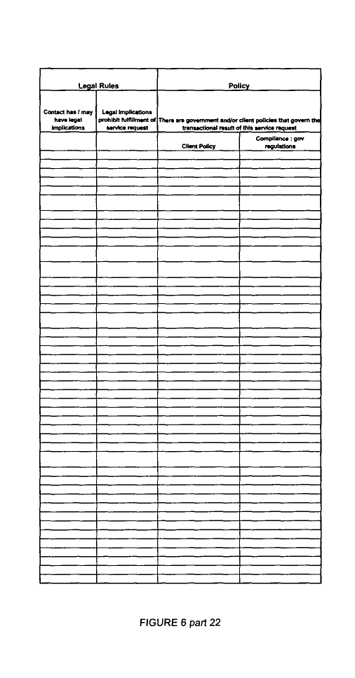

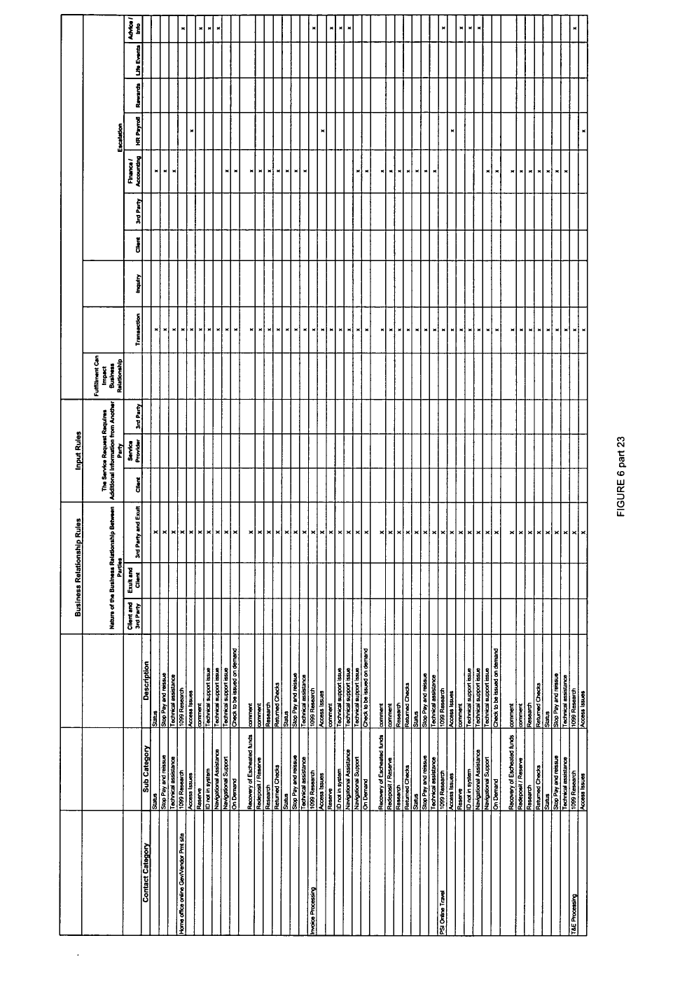

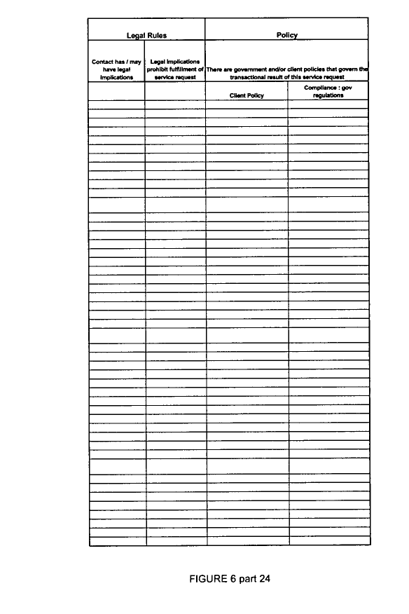

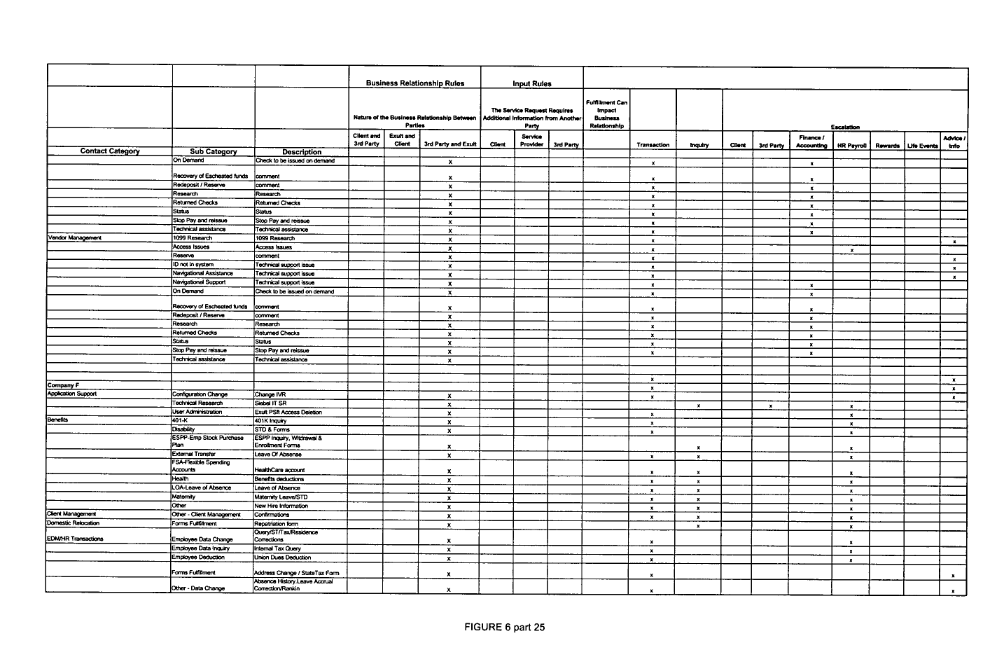

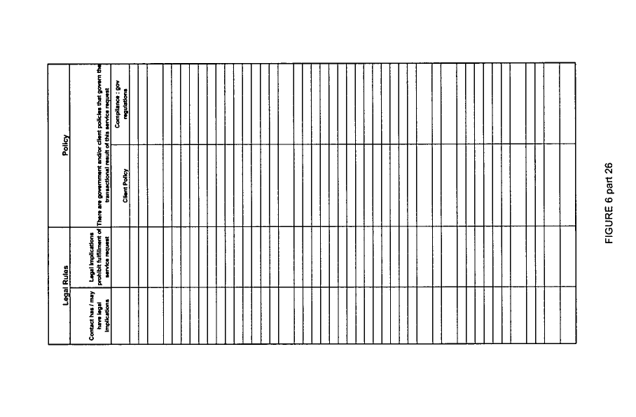

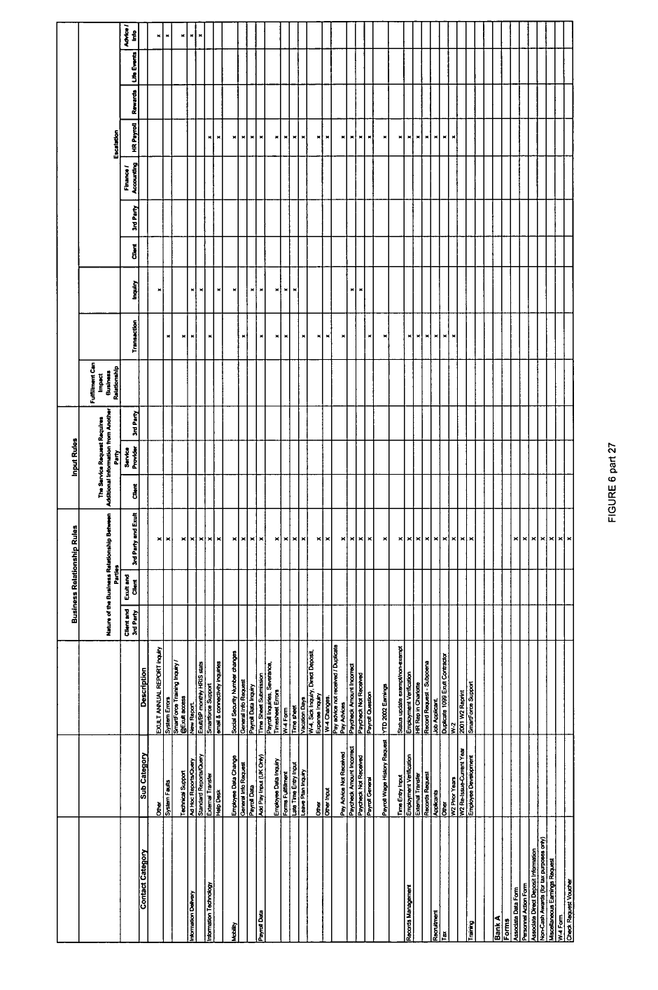

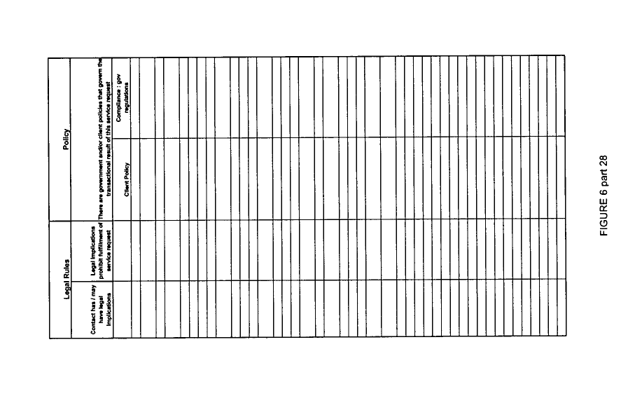

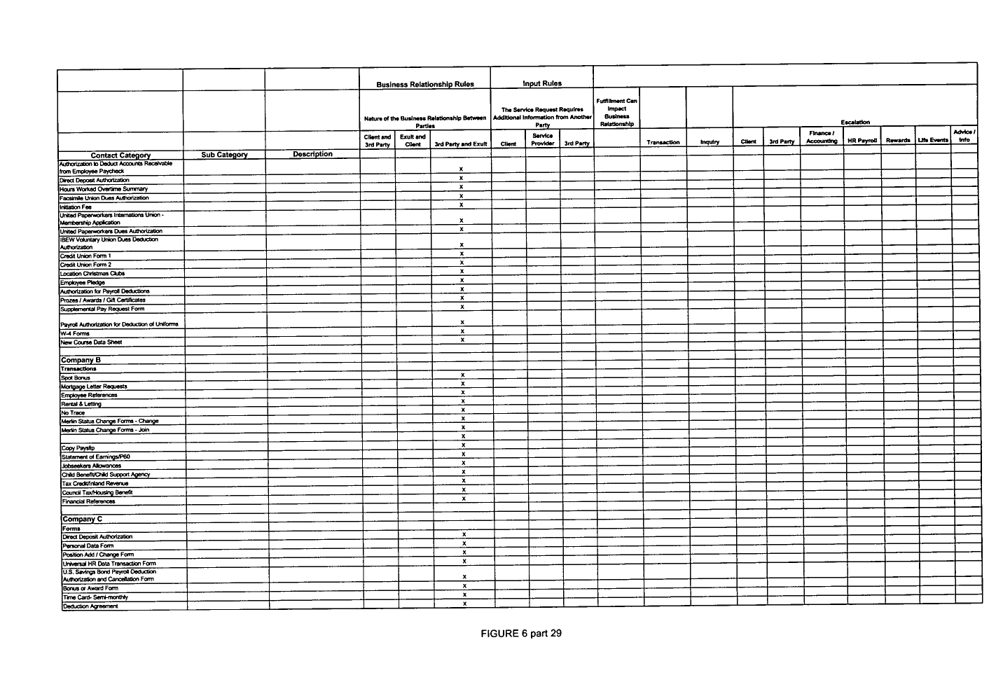

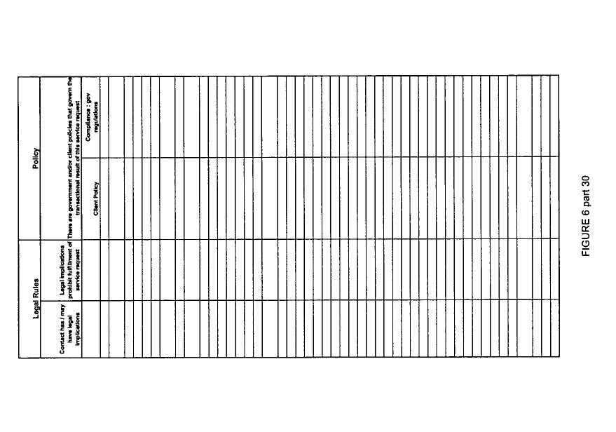

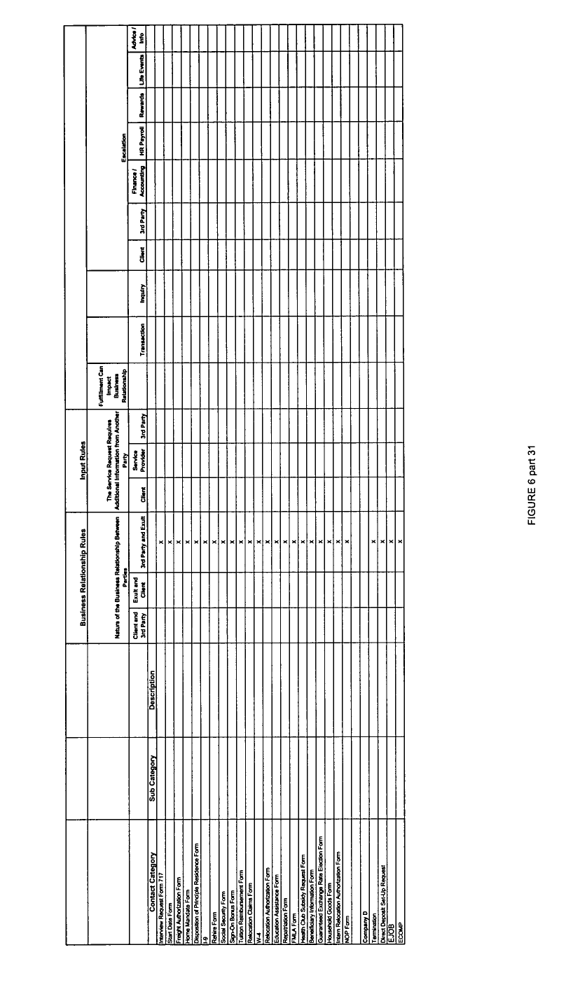

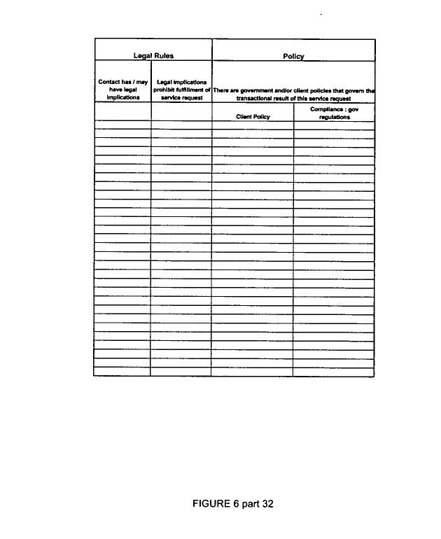

Referring now to FIG. 6, there is shown a third table constructed in accordance with the principles of the present invention. This table illustrates how the one or more attributes comprising a service request may enable an evaluation of the fulfillment or non-fulfillment of the service request. For example, the service request may be described by the attribute “additional information”, and the value of the attribute may be “yes” or “no”. Thus, the “additional information” attribute with a value of “yes” indicates that fulfillment of the service request will require information in addition to that provided by the requestor 100. As another example, the service request may be described by the attribute “legal implications prevent service request from being fulfilled”, and the value of this attribute may be “yes” or “no”. Thus, a service request having this attribute with the value “yes” may be evaluated for non-fulfillment in step 310 and this information may be transmitted to the requestor 100 to explain the non-fulfillment of the service request.

It will be understood that the invention may be embodied in other specific forms without departing from the spirit or central characteristics thereof. The present embodiments, therefore, are to be considered in all respects as illustrative and not restrictive, and the invention is not to be limited to the details given herein.

1. A method for managing service requests, the method comprising the steps of:
providing for receiving a service request from a service requestor;
providing for determining which of a plurality of service-providing nodes to transmit the service request to; and,
providing for transmitting the service request to at least one of the plurality of service-providing nodes.

2. The method of claim 1, further comprising the step of:
providing for formatting the service request into a predetermined service request format.

3. The method of claim 1, further comprising the step of:
providing for assigning a unique service request identifier to the service request.

4. The method of claim 1, further comprising the step of:
providing for determining whether the service request contains information required for the fulfillment of the service request.

5. The method of claim 4, further comprising the step of:
providing for transmitting the service request to the service requestor if the service request does not contain information required for the fulfillment of the service request.

6. The method of Claim I, further comprising the step of:
providing for determining whether fulfillment of the service request requires authorization from an authorization provider.

7. The method of claim 6, further comprising the step of:
providing for transmitting the service request to an authorization provider.

8. The method of claim 6, further comprising the step of:
providing for receiving an authorization from an authorization provider.

9. The method of claim 1, further comprising the step of:
providing for determining whether fulfillment of the service request requires transmitting the service request to more than one of the plurality of service-providing nodes.

10. The method of claim 9, further comprising the steps of:
providing for dividing the service request into a plurality of portions; and,
providing for transmitting each of the plurality of portions of the service request to a separate one of the plurality of service-providing nodes.

11. The method of claim 9, further comprising the steps of:
providing for receiving fulfillment information from at least one of the plurality of service-providing nodes; and,
providing for assembling the fulfillment information received from the at least one of the plurality of service-providing nodes.

12. The method of claim 1, further comprising the step of:
providing for receiving fulfillment information from one of the plurality of service-providing nodes.

13. The method of claim 1, further comprising the step of:
providing for determining whether the service request has been fulfilled.

14. The method of claim 13, further comprising the step of:
providing for transmitting the service request to a service-providing node upon a determination that a deficiency has been overcome or is no longer relevant.

15. The method of claim 13, further comprising the step of:
providing for notifying the service requestor whether the service request has been fulfilled.

16. The method of claim 13, further comprising the step of:
providing for determining why the service request was not fulfilled; and,
providing for transmitting to the service requestor results of why the service request was not fulfilled.

17. The method of claim 1, further comprising the step of:
providing for monitoring the status of the service request.

18. The method of claim 17, further comprising the step of:
providing for receiving a request from a service requestor for the status of the service request; and,
providing for transmitting the status of the service request to a service requester.

19. The method of claim 1, further comprising the step of:
providing for retrievably storing information related to the service request.

20. The method of claim 1, wherein the service request comprises at least one attribute, further comprising the steps of:
providing for evaluating the service request based on the value of the at least one attribute; and,
providing for proposing a response to the service request based on the evaluation of the service request.

21. The method of claim 1, wherein the step of providing for determining which of the plurality of nodes to transmit the service request to is dependent on at least one of: a requestor location, a service-providing node location, a location of provider resources, a language of the requester, a service request language, a subject matter of the service request, time the service request is received, time required for fulfillment of the service request, confidentiality of the service request, identify of the requestor, number of requestors.

22. A method for managing service requests, the method comprising the steps of:
providing for receiving a service request from a service requester, the service request having at least one attribute;
providing for evaluating the service request based on the value of the at least one attribute; and,
providing for proposing a response to the service request based on the evaluation of the service request.

23. The method of claim 22, further comprising the step of:
providing for formatting the service request into a predetermined service request format.

24. The method of claim 22, further comprising the step of:
providing for assigning a unique service request identifier to the service request.

25. The method of claim 22, further comprising the step of:
providing for determining whether the service request contains information required for the fulfillment of the service request.

26. The method of claim 22, further comprising the step of:
providing for transmitting the service request to the service requestor if the service request does not contain information required for the fulfillment of the service request.

27. The method of claim 22, further comprising the step of:
providing for determining whether fulfillment of the service request requires authorization from an authorization provider.

28. The method of claim 27, further comprising the step of:
providing for transmitting the service request to an authorization provider.

29. The method of claim 27, further comprising the step of:
providing for receiving an authorization from an authorization provider.

30. The method of claim 22, further comprising the step of:
providing for determining whether fulfillment of the service request requires transmitting the service request to more than one of the plurality of service-providing nodes.

31. The method of claim 30, further comprising the steps of:
providing for dividing the service request into a plurality of portions; and,
providing for transmitting each of the plurality of portions of the service request to a separate one of the plurality of service-providing nodes.

32. The method of claim 30, further comprising the steps of:
providing for receiving fulfillment information from at least one of the plurality of service-providing nodes; and,
providing for assembling the fulfillment information received from the at least one of the plurality of service-providing nodes.

33. The method of claim 22, further comprising the step of:
providing for receiving fulfillment information from one of the plurality of service-providing nodes.

34. The method of claim 22, further comprising the step of:
providing for determining whether the service request has been fulfilled.

35. The method of claim 34, further comprising the step of:
providing for transmitting the service request to a service-providing node upon a determination that a deficiency has been overcome or is no longer relevant.

36. The method of claim 34, further comprising the step of:
providing for notifying the service requestor whether the service request has been fulfilled.

37. The method of claim 34, further comprising the steps of:
providing for determining why the service request was not fulfilled; and,
providing for transmitting to the service requestor results of why the service request was not fulfilled.

38. The method of claim 22, further comprising the step of:
providing for monitoring the status of the service request.

39. The method of claim 38, further comprising the steps of:
providing for receiving a request from a service requestor for the status of the service request; and,
providing for transmitting the status of the service request to a service requester.

40. The method of claim 22, further comprising the step of:
providing for retrievably storing information related to the service request.

41. The method of claim 22, wherein the proposed response is dependent on at least one of: a requester location, a service-providing node location, a location of provider resources, a language of the requestor, a service request language, a subject matter of the service request, time the service request is received, time required for fulfillment of the service request, confidentiality of the service request, identify of the requester, number of requesters.

42. A system for managing service requests, comprising:
a processor for executing an application; and,
a memory in communication with the processor;
wherein the application comprises:
a first code segment for receiving a service request from a service requester;
a second code segment for determining which of a plurality of service-providing nodes to transmit the service request to; and,
a third code segment for transmitting the service request to at least one of the plurality of service-providing nodes.

43. The system of claim 42, wherein the application further comprises:
a fourth code segment for formatting the service request into a predetermined service request format.

44. The system of claim 42, wherein the application further comprises:
a fourth code segment for assigning a unique service request identifier to the service request.

45. The system of claim 42, wherein the application further comprises:
a fourth code segment for determining whether the service request contains information required for the fulfillment of the service request.

46. The system of claim 42, wherein the application further comprises:
a fifth code segment for transmitting the service request to the service requestor if the service request does not contain information required for the fulfillment of the service request.

47. The system of claim 42, wherein the application further comprises:
a fourth code segment for determining whether fulfillment of the service request requires authorization from an authorization provider.

48. The system of claim 47, wherein the application further comprises:
a fifth code segment for transmitting the service request to an authorization provider.

49. The system of claim 47, wherein the application further comprises:
a fifth code segment for receiving an authorization from an authorization provider.

50. The system of claim 42, wherein the application further comprises:
a fourth code segment for determining whether fulfillment of the service request requires transmitting the service request to more than one of the plurality of service-providing nodes.

51. The system of claim 50, wherein the application further comprises:
a fifth code segment for dividing the service request into a plurality of portions; and,
a sixth code segment for transmitting each of the plurality of portions of the service request to a separate one of the plurality of service-providing nodes.

52. The system of claim 50, wherein the application further comprises:
a fifth code segment for receiving fulfillment information from at least one of the plurality of service-providing nodes; and,
a sixth code segment for assembling the fulfillment information received from the at least one of the plurality of service-providing nodes.

53. The system of claim 42, wherein the application further comprises:
a fourth code segment for receiving fulfillment information from one of the plurality of service-providing nodes.

54. The system of claim 42, wherein the application further comprises:
a fourth code segment for determining whether the service request has been fulfilled.

56. The system of claim 54, wherein the application further comprises:
a fifth code segment for transmitting the service request to a service-providing node upon a determination that a deficiency has been overcome or is no longer relevant.

57. The system of claim 54, wherein the application further comprises:
a fifth code segment for notifying the service requester whether the service request has been fulfilled.

58. The system of claim 54, wherein the application further comprises:
a fifth code segment for determining why the service request was not fulfilled; and,
a sixth code segment for transmitting to the service requestor results of why the service request was not fulfilled.

59. The system of claim 42, wherein the application further comprises:
a fourth code segment for monitoring the status of the service request.

60. The system of claim 59, wherein the application further comprises:
a fifth code segment for receiving a request from a service requestor for the status of the service request; and,
a sixth code segment for transmitting the status of the service request to a service requestor.

61. The system of claim 42, wherein the application further comprises:
a fourth code segment for retrievably storing information related to the service request.

62. The system of claim 42, wherein the service request comprises at least one attribute, the application further comprising:
a fourth code segment for evaluating the service request based on the value of the at least one attribute; and,
a fifth code segment for proposing a response to the service request based on the evaluation of the service request.

63. The system of claim 42, wherein the outcome of the second code segment is dependent on at least one of: a requestor location, a service-providing node location, a location of provider resources, a language of the requestor, a service request language, a subject matter of the service request, time the service request is received, time required for fulfillment of the service request, confidentiality of the service request, identify of the requestor, number of requesters.

64. A system for managing service requests, comprising:
a processor for executing an application; and,
a memory in communication with the processor,
wherein the application comprises:
a first code segment for receiving a service request from a service requestor, the service request having at least one attribute;
a second code segment for evaluating the service request based on the value of the at least one attribute; and,
a third code segment for proposing a response to the service request based on the evaluation of the service request.

65. The system of claim 64, wherein the application further comprises:
a fourth code segment for formatting the service request into a predetermined service request format.

66. The system of claim 64, wherein the application further comprises:
a fourth code segment for assigning a unique service request identifier to the service request.

67. The system of claim 64, wherein the application further comprises:
a fourth code segment for determining whether the service request contains information required for the fulfillment of the service request.

68. The system of claim 64, wherein the application further comprises:
a fourth code segment for transmitting the service request to the service requestor if the service request does not contain information required for the fulfillment of the service request.

69. The system of claim 64, wherein the application further comprises:
a fourth code segment for determining whether fulfillment of the service request requires authorization from an authorization provider.

70. The system of claim 64, wherein the application further comprises:
a fourth code segment for transmitting the service request to an authorization provider.

71. The system of claim 64, wherein the application further comprises:
a fourth code segment for receiving an authorization from an authorization provider.

72. The system of claim 64, wherein the application further comprises:
a fourth code segment for determining whether fulfillment of the service request requires transmitting the service request to more than one of the plurality of service-providing nodes.

73. The system of claim 72, wherein the application further comprises:
a fifth code segment for dividing the service request into a plurality of portions; and,
a sixth code segment for providing for transmitting each of the plurality of portions of the service request to a separate one of the plurality of service-providing nodes.

74. The system of claim 72, wherein the application further comprises:
a fifth code segment for receiving fulfillment information from at least one of the plurality of service-providing nodes; and,
a sixth code segment providing for assembling the fulfillment information received from the at least one of the plurality of service-providing nodes.

75. The system of claim 64, wherein the application further comprises:
a fourth code segment for receiving fulfillment information from one of the plurality of service-providing nodes.

76. The system of claim 64, wherein the application further comprises:
a fourth code segment for determining whether the service request has been fulfilled.

77. The system of claim 76, wherein the application further comprises:
a fifth code segment for transmitting the service request to a service-providing node upon a determination that a deficiency has been overcome or is no longer relevant.

78. The system of claim 76, wherein the application further comprises:
a fifth code segment for notifying the service requestor whether the service request has been fulfilled.

79. The system of claim 64, wherein the application further comprises:
a fifth code segment for determining why the service request was not fulfilled; and,
a sixth code segment for transmitting to the service requestor results of why the service request was not fulfilled.

80. The system of claim 64, wherein the application further comprises:
a fourth code segment for monitoring the status of the service request.

81. The system of claim 80, wherein the application further comprises:
a fifth code segment for receiving a request from a service requestor for the status of the service request; and,
a sixth code segment for transmitting the status of the service request to a service requestor.

82. The system of claim 64, wherein the application further comprises:
a fourth code segment for retrievably storing information related to the service request.

83. The system of claim 64, wherein the application further comprises:
a fourth code segment for

84. The system of claim 64, wherein the step wherein the outcome of the second code segment is dependent on at least one of: a requester location, a service-providing node location, a location of provider resources, a language of the requester, a service request language, a subject matter of the service request, time the service request is received, time required for fulfillment of the service request, confidentiality of the service request, identify of the requester, number of requesters.
